(19) United States
(12) Patent Application Publication
(10) Pub. No.: US 2008/0281604 A1
(43) Pub. Date: Nov. 13, 2008

(54) METHOD AND APPARATUS TO ENCODE AND DECODE AN AUDIO SIGNAL

(75) Inventors: Ki-hyun CHOO, Seoul (KR); Anton Porov, Yongin-si (KR); Eun-mi Oh, Seongnam-si (KR); Jung-hoe Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/956,690

(22) Filed: Dec. 14, 2007

(30) Foreign Application Priority Data
May 8, 2007 (KR) 2007-44717

(51) Int. Cl. G10L 19/00

(52) U.S. Cl. 704/500; 704/E19.001

(57) ABSTRACT

A method and apparatus to encode and decode an audio signal. In the encoding method and apparatus, one or more important frequency components may be detected from an audio signal, the frequency components may be encoded, and then an envelope of the audio signal may be encoded. In the decoding method and apparatus, an audio signal may be decoded by adjusting envelopes at one or more bands containing one or more important frequency components in consideration of the energy values of the frequency components. Accordingly, it is possible to maximize the coding efficiency without degrading the sound quality of the audio signal even if the audio signal is encoded or decoded using a small amount of bits.

### CROSS-REFERENCE TO RELATED APPLICATIONS

This application claims the benefit of Korean Patent Application No. 10-2007-0044717, filed on May 8, 2007, in the Korean Intellectual Property Office, the disclosure of which is hereby incorporated herein in its entirety by reference.

### BACKGROUND OF THE INVENTION

1. Field of the Invention

The present general inventive concept relates to a method and apparatus to encode and decode an audio signal, such as a speech signal or a music signal, and more particularly, to a method and apparatus to efficiently encode and decode an audio signal in a restricted environment.

2. Description of the Related Art

Encoding or decoding of an audio signal is limited by environment, such as data size or a data transmission rate. Thus, it is very important to improve the quality of sound in such a restricted environment. To this end, encoding must be performed in such a manner that more bits are assigned to data of an audio signal that is important for a human to recognize the audio signal compared to other data of the audio signal that is less important.

### SUMMARY OF THE INVENTION

The present general inventive concept provides a method and apparatus to detect one or more important frequency components from an audio signal, encoding the frequency components, and then encoding an envelope of the audio signal.

The present general inventive concept also provides a method and apparatus to decode an audio signal by adjusting an envelope at each of one or more bands containing important one or more frequency components in consideration of the energy value of each of the frequency component(s).

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing a method of encoding an audio signal, including detecting one or more frequency components from a received audio signal according to predetermined criteria, and then encoding the detected one or more frequency components, and calculating energy values of the received signal in predetermined frequency band units, and then encoding the calculated energy values.

The foregoing and/or other aspects and utilities of the present general inventive concept can also be achieved by providing a method of encoding an audio signal, including detecting one or more frequency components from a received signal according to predetermined criteria, and then encoding the detected one or more frequency components; and extracting and encoding an envelope of the received signal.

The foregoing and/or other aspects and utilities of the present general inventive concept can also be achieved by providing a method of encoding an audio signal, including detecting one or more frequency components from a plurality of received signals according to predetermined criteria, and then encoding the detected one or more frequency components, calculating an energy value of each of one or more signals having a frequency band less than a predetermined frequency from among the received signals, in predetermined frequency band units, and then encoding the energy values, and encoding one or more signals having a frequency band greater than the predetermined frequency by using the one or more signals having a frequency band less than the predetermined frequency.

The methods may further include encoding a tonality of each of one or more signals at one or more predetermined bands.

The foregoing and/or other aspects and utilities of the present general inventive concept can also be achieved by providing a method of decoding an audio signal, including decoding one or more frequency components, decoding an energy value of each of one or more signals to be respectively generated at bands, calculating an energy value of each of the one or more signals, based on the decoded energy values and in consideration of energy values of the decoded frequency components, respectively generating the one or more signals having one of the calculated energy values at the bands, and mixing the frequency components and the generated signals.

During the calculating of the energy values, the energy values of the one or more signals to be generated at each band may be calculated by subtracting the energy value of each of the frequency components each of which are contained in one of the bands from the decoded energy value at each band.

During the generating of the one or more signals, the one or more signals may be arbitrarily generated.

During the generating of the one or more signals, the one or more signals may further be generated by duplicating one or more signals corresponding to frequency bands less than a predetermined frequency.

During the generating of the one or more signals, the one or more signals may further be generated using one or more signals corresponding to a frequency band less than a predetermined frequency.

The method may further include decoding a tonality of each of one or more predetermined bands.

During the calculating of the energy value, the tonality of each of the one or more predetermined bands may also be considered.

The foregoing and/or other aspects and utilities of the present general inventive concept can also be achieved by providing a method of decoding an audio signal, including decoding one or more frequency components, encoding one or more envelopes of the audio signal, adjusting the one or more envelopes at respective bands in consideration of energy values of the one or more frequency components at the respective bands, and mixing the one or more frequency components and the adjusted envelopes.

During the adjusting of the envelopes, the envelope at each band may be adjusted so that the energy value of the decoded envelope at each band is equal to the value obtained by subtracting an energy value of each of the one or more frequency components contained in the bands from the energy value of an envelope at each of the bands containing the one or more decoded frequency components.

The foregoing and/or other aspects and utilities of the present general inventive concept can also be achieved by providing a method of decoding an audio signal, including decoding one or more frequency components, decoding an energy value of a signal at each of a plurality of frequency bands less than a predetermined frequency, calculating an energy value of a signal to be generated at each band, based on one of the decoded energy values and in consideration of an energy value of each of the one or more frequency components, generating a signal having one of the calculated energy values at each frequency band less than the predetermined frequency, decoding a signal at each frequency band greater than the predetermined frequency by using the signal at each band less than the predetermined frequency, adjusting the signal at each frequency band greater than the predetermined frequency in consideration of the energy values of the one or more frequency components at the respective bands, and mixing the one or more frequency components, the generated signals, and the adjusted signals.

During the calculating of the energy values, the energy value of a signal to be generated at each band may be calculated by subtracting the energy value of one of the one or more frequency components contained in the respective bands from the decoded energy value of each band.

During the generating of the signals, the signals may be generated by duplicating the signal at each frequency band less than the predetermined frequency.

During the generating of the signals, the signals may further be generated using the signal at each frequency band less than the predetermined frequency.

The method may further include performing frame synchronization if frames applied to the decoding of the one or more frequency components are not the same as frames applied to the generating of the signals or the decoding of the signal at each frequency band greater than the predetermined frequency.

The foregoing and/or other aspects and utilities of the present general inventive concept can also be achieved by providing a computer readable medium having recorded thereon a computer readable recording medium having recorded thereon a computer program to execute a method of encoding an audio signal, the method including detecting one or more frequency components from a received signal according to predetermined criteria, and then encoding the detected one or more frequency components, and calculating energy values of the received signal in predetermined frequency band units, and then encoding the calculated energy values.

The foregoing and/or other aspects and utilities of the present general inventive concept can also be achieved by providing a computer readable medium having recorded thereon a computer readable recording medium having recorded thereon a computer program to execute a method of encoding an audio signal, the method including detecting one or more frequency components from a received signal according to predetermined criteria, and then encoding the detected one or more frequency components, and extracting and encoding one or more envelopes of the received signal.

The foregoing and/or other aspects and utilities of the present general inventive concept can also be achieved by providing a computer readable medium having recorded thereon a computer readable recording medium having recorded thereon a computer program to execute a method of encoding an audio signal, the method including detecting one or more frequency components from a plurality of received signals according to predetermined criteria, and then encoding the detected one or more frequency components, calculating an energy value of each of one or more signals having a frequency band less than a predetermined frequency from the received signals, in predetermined frequency band units, and then encoding the energy values, and encoding one or more signals having a frequency band greater than the predetermined frequency by using the one or more signals having a frequency band less than the predetermined frequency.

The foregoing and/or other aspects and utilities of the present general inventive concept can also be achieved by providing a computer readable medium having recorded thereon a computer readable recording medium having recorded thereon a computer program to execute a method of decoding an audio signal, the method including decoding one or more frequency components, decoding an energy value of each of one or more signals to be respectively generated at bands, calculating an energy value of each of the one or more signals, based on the decoded energy values and in consideration of energy values of the decoded one or more frequency components, respectively generating the one or more signals having one of the calculated energy values at the bands, and mixing the one or more frequency components and the one or more generated signals.

The foregoing and/or other aspects and utilities of the present general inventive concept can also be achieved by providing a computer readable medium having recorded thereon a computer readable recording medium having recorded thereon a computer program to execute a method of decoding an audio signal, the method including decoding one or more frequency components, encoding one or more envelopes of the audio signal, adjusting the one or more envelopes at respective bands in consideration of energy values of the one or more frequency components at the respective bands, and mixing the one or more frequency components and the one or more adjusted envelopes.

The foregoing and/or other aspects and utilities of the present general inventive concept can also be achieved by providing a computer readable medium having recorded thereon a computer readable recording medium having recorded thereon a computer program to execute a method of decoding an audio signal, the method including decoding one or more frequency components, decoding an energy value of a signal at each of frequency bands less than a predetermined frequency; calculating an energy value of a signal to be generated at each band, based on one of the decoded energy values and in consideration of an energy value of each of the one or more frequency components, generating a signal having one of the calculated energy values at each frequency band less than the predetermined frequency, decoding a signal at each frequency band greater than the predetermined frequency by using the signal at each band less than the predetermined frequency, adjusting the signal at each frequency band greater than the predetermined frequency in consideration of the energy values of the one or more frequency components at the respective bands, and mixing the one or more frequency components, the generated signals, and the adjusted signals.

The foregoing and/or other aspects and utilities of the present general inventive concept can also be achieved by providing an apparatus to encode an audio signal, the apparatus including a frequency component encoding unit to detect one or more frequency components from a received signal according to predetermined criteria and then to encode the one or more frequency components, and an energy value encoding unit to calculate and encode energy values of the received signal in predetermined frequency band units.

The foregoing and/or other aspects and utilities of the present general inventive concept can also be achieved by providing an apparatus to encode an audio signal, the apparatus including a frequency component encoding unit to detect one or more frequency components from a received signal according to predetermined criteria and then to encode the one or more frequency components, and an envelope encoding unit to extract and encode one or more envelopes of the received signal.

The foregoing and/or other aspects and utilities of the present general inventive concept can also be achieved by providing an apparatus to encode an audio signal, the apparatus including a frequency component encoding unit to detect one or more frequency components from a plurality of received signals according to predetermined criteria and then to encode the frequency components, an energy value encoding unit to calculate and encode energy values of one or more signals at a frequency band less than a predetermined frequency from among the received signals, and a bandwidth extension encoding unit to encode one or more signals at a frequency band greater than the predetermined frequency from among the received signals by using the one or more signals at a frequency band less than the predetermined frequency.

The foregoing and/or other aspects and utilities of the present general inventive concept can also be achieved by providing an apparatus to decode an audio signal, the apparatus including a frequency component decoding unit to decode one or more frequency components, an energy value decoding unit to decode an energy value of a signal to be generated at each of a plurality of bands, an energy value calculation unit to calculate an energy value of a signal to be generated at each band, based on the decoded energy values and in consideration of energy values of the decoded one or more frequency components, a signal generation unit to generate a signal having one of the calculated energy values at each band, and a signal mixing unit to mix the one or more frequency components and the generated signals.

The foregoing and/or other aspects and utilities of the present general inventive concept can also be achieved by providing an apparatus to decode an audio signal, the apparatus including a frequency component decoding unit to decode one or more frequency components, an envelope decoding unit to decode envelopes of the audio signal, an envelope adjustment unit to adjust the envelopes at a plurality of respective bands in consideration of energy values of the one or more frequency components at the respective bands, and a signal mixing unit to mix the one or more frequency components and the adjusted envelopes.

The foregoing and/or other aspects and utilities of the present general inventive concept can also be achieved by providing an apparatus to decode an audio signal, the apparatus including a frequency component decoding unit to decode one or more frequency components, an energy value decoding unit to decode an energy value of a signal at each of a plurality of frequency bands less than a predetermined frequency, an energy value calculation unit to calculate an energy value of a signal that is to be generated at each band, based on the decoded energy values and in consideration of energy values of the decoded frequency components, a signal generation unit to generate a signal having one of the calculated energy values at each frequency band less than the predetermined frequency, a bandwidth extension decoding unit to decode a signal at each frequency band greater than the predetermined frequency by using the signal at each frequency band less than the predetermined frequency, a signal adjustment unit to adjust the decoded signal at each frequency band greater than the predetermined frequency in consideration of the energy values of the one or more frequency components at the respective bands, and a signal mixing unit to mix the one or more frequency components, the generated signals, and the adjusted signals.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of an apparatus to encode an audio signal, according to an embodiment of the present general inventive concept;

FIG. 2 is a block diagram of an apparatus to decode an audio signal, according to another embodiment of the present general inventive concept;

FIG. 3 is a block diagram of an apparatus to encode an audio signal, according to another embodiment of the present general inventive concept;

FIG. 4 is a block diagram of an apparatus to decode an audio signal, according to another embodiment of the present general inventive concept;

FIG. 5 is a block diagram of an apparatus to encode an audio signal, according to another embodiment of the present general inventive concept;

FIG. 6 is a block diagram of an apparatus to decode an audio signal, according to another embodiment of the present general inventive concept;

FIG. 7 is a block diagram of an apparatus to encode an audio signal, according to another embodiment of the present general inventive concept;

FIG. 8 is a block diagram of an apparatus to decode an audio signal, according to another embodiment of the present general inventive concept;

FIG. 9 is a block diagram of an apparatus to encode an audio signal, according to another embodiment of the present general inventive concept;

FIG. 10 is a block diagram of an apparatus to decode an audio signal, according to another embodiment of the present general inventive concept;

FIG. 11 is a block diagram of an apparatus to encode an audio signal, according to another embodiment of the present general inventive concept;

FIG. 12 is a block diagram of a signal adjustment unit included in an apparatus to decode an audio signal, according to another embodiment of the present general inventive concept;

FIG. 13 is a block diagram of a signal adjustment unit included in a decoding apparatus, according to another embodiment of the present general inventive concept;

FIG. 14 is a circuit diagram illustrating application of a gain when a signal generation unit illustrated in FIG. 2, 6, 8 or 10 generates a signal from only a single signal, according to an embodiment of the present general inventive concept;

FIG. 15 is a circuit diagram illustrating application of a gain when the signal generation unit illustrated in FIG. 2, 6, 8 or 10 generates a signal from a plurality of signals, according to an embodiment of the present general inventive concept;

FIG. 16 is a flowchart illustrating a method of encoding an audio signal, according to an embodiment of the present general inventive concept;

FIG. 17 is a flowchart illustrating a method of decoding an audio signal, according to an embodiment of the present general inventive concept;

FIG. 18 is a flowchart illustrating a method of encoding an audio signal, according to another embodiment of the present general inventive concept;

FIG. 19 is a flowchart illustrating a method of decoding an audio signal, according to another embodiment of the present general inventive concept;

FIG. 20 is a flowchart illustrating a method of encoding an audio signal, according to another embodiment of the present general inventive concept;

FIG. 21 is a flowchart illustrating a method of decoding an audio signal, according to another embodiment of the present general inventive concept;

FIG. 22 is a flowchart illustrating a method of encoding an audio signal, according to another embodiment of the present general inventive concept;

FIG. 23 is a flowchart illustrating a method of decoding an audio signal, according to another embodiment of the present general inventive concept;

FIG. 24 is a flowchart illustrating a method of encoding an audio signal, according to another embodiment of the present general inventive concept;

FIG. 25 is a flowchart illustrating a method of decoding an audio signal, according to another embodiment of the present general inventive concept;

FIG. 26 is a flowchart illustrating a method of encoding an audio signal, according to another embodiment of the present general inventive concept;

FIG. 27 is a flowchart illustrating a method of decoding an audio signal, according to another embodiment of the present general inventive concept; and

FIG. 28 is a flowchart illustrating in detail operation 1720, 2120, 2325 or 2520 illustrated in FIG. 17, 21, 23 or 25, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

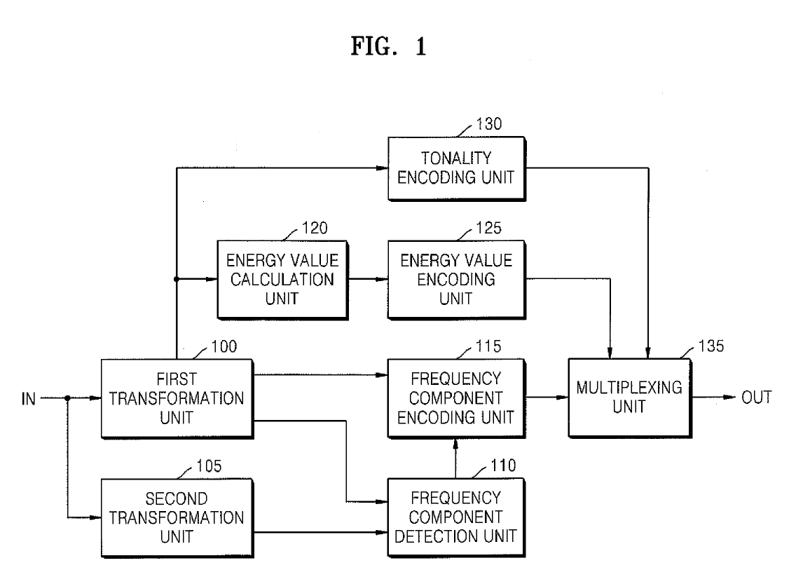

FIG. 1 is a block diagram of an apparatus to encode an audio signal, according to an embodiment of the present general inventive concept. The encoding apparatus may include a first transformation unit 100, a second transformation unit 105, a frequency component detection unit 110, a frequency component encoding unit 115, an energy value calculation unit 120, an energy value encoding unit 125, a tonality encoding unit 130, and a multiplexing unit 135.

The first transformation unit 100 may transform an audio signal received via an input terminal IN from the time domain to the frequency domain, by using a first predetermined transformation method. Examples of the audio signal are a speech signal and a music signal.

The second transformation unit 105 may transform the received audio signal from the time domain to the frequency domain by using a second transformation method that is different to the first transformation method, in order to apply a psycho acoustic model.

The signal transformed by the first transformation unit 100 may be used to encode the audio signal. The signal transformed by the second transformation unit 105 may be used to detect an important frequency component by applying the psychoacoustic model to the audio signal. The psychoacoustic model refers to a mathematical model regarding a masking reaction of the human auditory system.

For example, the first transformation unit 100 may represent the audio signal with real numbers by transforming it into the frequency domain by using Modified Discrete Cosine Transform (MDCT) as the first transformation method, and the second transformation unit 105 may represent the audio signal with imaginary numbers by transforming it into the frequency domain by using Modified Discrete Sine Transform (MDST) as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Thus, since phase information of the audio signal can be further represented, Discrete Fourier Transformation (DFT) may be performed on a signal corresponding to the time domain and then MDCT coefficients may be quantized, thereby preventing a mismatch from occurring.

The frequency component detection unit 110 may detect one or more important frequency components from the signal transformed by the first transformation unit 100 according to predetermined criteria, by using the signal transformed by the second transformation unit 105. In this case, the frequency component detection unit 110 may use various methods in order to detect important frequency components. First, a signal-to-masking ratio (SMR) of a signal may be calculated and then the signal may be determined as an important frequency component if the SMR is greater than a reciprocal number of a masking value. Second, whether a frequency component is important may be determined by extracting a spectrum peak in consideration of a predetermined weight. Third, a signal-to-noise ratio (SNR) of each of sub bands may be calculated, and then frequency components from among sub bands having a small SNR, which have a peak value equal to or greater than a predetermined value, may be determined as important frequency components. The above three methods may be individually performed, or one or a combination of at least two of the three methods may be performed. The above three methods are just examples and thus the present general inventive concept is not limited thereto.

The frequency component encoding unit 115 may encode the frequency component(s) detected by the frequency component detection unit 110, and information representing the location(s) of the frequency component(s).

The energy value calculation unit 120 may calculate an energy value of a signal at each of bands of the signal transformed by the first transformation unit 100. Here, each band may be a sub band or a scale factor band in the case of a Quadrature Mirror Filter (QMF).

The energy value encoding unit 125 may encode the energy values of the bands calculated by the energy value calculation unit 120 and information representing locations of the bands.

The tonality encoding unit 130 may calculate and encode a tonality of a signal at each band containing the frequency component(s) detected by the frequency component detection unit 110. The tonality encoding unit 130 is not indispensable to the present general inventive concept but may be needed when a decoding apparatus (not shown) generates a signal from a plurality of signals, rather than from a single signal, at the band(s) having the frequency component(s). For example, the tonality encoding unit 130 may be needed for the decoding apparatus to generate one or more signals at the band(s) having the frequency component(s) by using both a signal being arbitrarily generated and a patched signal.

The multiplexing unit 135 may multiplex into a bitstream all the frequency component(s) and information representing the location(s) of the frequency component(s) that may be encoded by the frequency component encoding unit 115, and the energy values of the bands and the information representing the locations of the bands that may be encoded by the energy value encoding unit 125, and then may output the bitstream via an output terminal OUT. Alternatively, the tonality (or tonalities) encoded by the tonality encoding unit 130 may also be multiplexed into the bitstream.

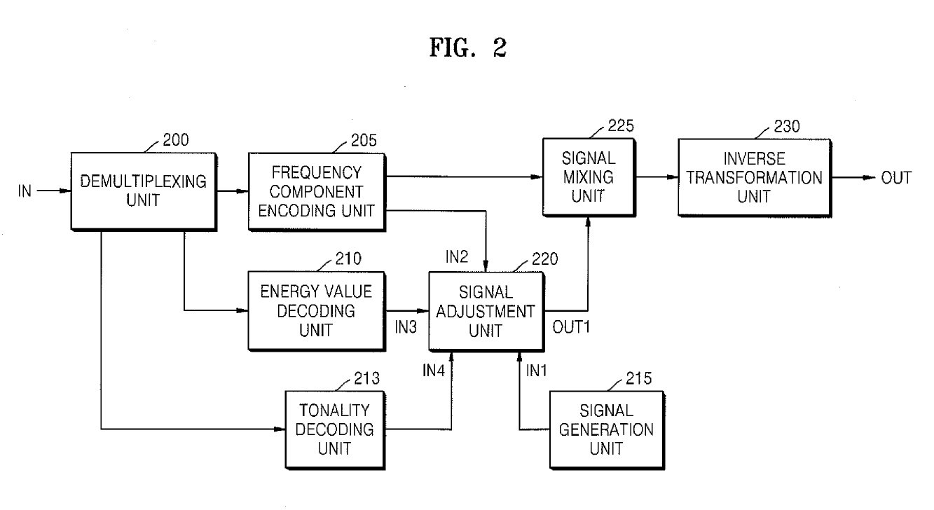

FIG. 2 is a block diagram of an apparatus to decode an audio signal according to an embodiment of the present general inventive concept. The decoding apparatus may include a demultiplexing unit 200, a frequency component decoding unit 205, an energy value decoding unit 210, a signal generation unit 215, a signal adjustment unit 220, a signal mixing unit 225, and an inverse transformation unit 230.

The demultiplexing unit 200 may receive a bitstream from an encoding terminal via an input terminal IN and then may demultiplex the received bitstream. For example, the demultiplexing unit 200 may demultiplex the bitstream into one or more frequency components, information representing location(s) of the frequency component(s), energy values of bands, information representing locations of bands whose energy values may be encoded by an encoding apparatus, and a tonality (or tonalities).

The frequency component decoding unit 205 may decode one or more predetermined frequency components that were determined as important frequency components according to predetermined criteria and then encoded by the encoding apparatus.

The energy value decoding unit 210 may decode an energy value of a signal at each of the bands.

The tonality decoding unit 213 may decode a tonality (or tonalities) of a signal (or signals) at a band (or bands) containing the frequency component(s) decoded by the frequency component decoding unit 205. However, the tonality decoding unit 213 is not indispensable to the present general inventive concept but may be needed when the signal generation unit 215 generates a signal from a plurality of signals, rather than from a single signal. For example, the tonality decoding unit 213 may be needed for the signal generating unit 215 to generate a signal at each band containing the frequency component(s) decoded by the frequency component decoding unit 205 by using both a signal being arbitrarily generated and a patched signal. If the tonality decoding unit 213 is included in the present general inventive concept, the signal adjustment unit 220 may adjust the signal generated by the signal generation unit 215 in consideration of the tonality (or tonalities) decoded by the tonality decoding unit 213.

The signal generation unit 215 may generate signals, each of which has the energy values of the bands decoded by the energy value decoding unit 210, for each band.

The signal generation unit 215 may use various methods in order to generate signals in the bands. First, the signal generation unit 215 may arbitrarily generate a noise signal, e.g., a random noise signal. Second, if a signal in a predetermined band is a high-frequency signal corresponding to a frequency band greater than a predetermined frequency and if a low-frequency signal corresponding to a frequency band less than the predetermined frequency has already been decoded and thus is available, the signal generation unit 215 may generate a signal by duplicating the low-frequency signal. For example, a signal may be generated by patching or folding the low-frequency signal.

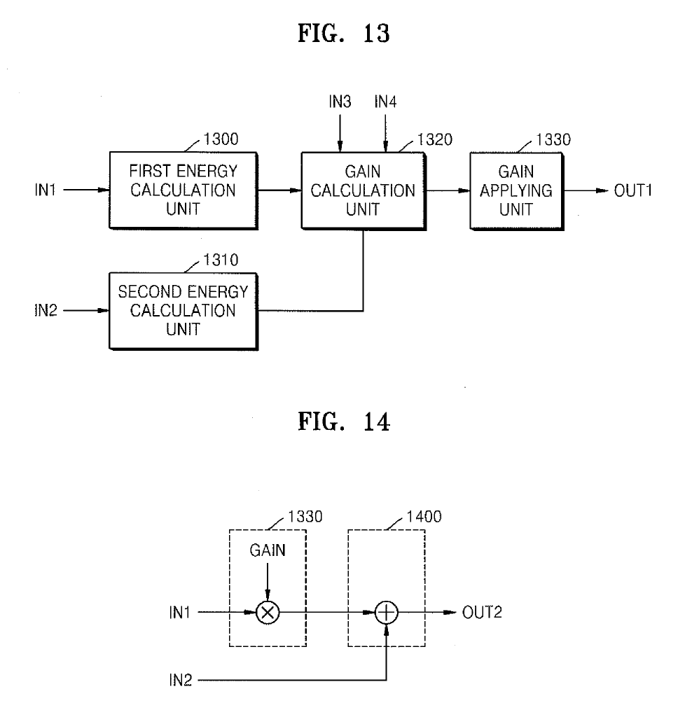

The signal adjustment unit 220 may adjust a signal (or signals) in the band(s) containing the frequency component(s) decoded by the frequency component decoding unit 205, from the signal(s) generated by the signal generation unit 215. Here, the signal adjustment unit 220 may adjust the signals generated by the signal generation unit 215 so that the energies of the signals can be adjusted, based on the energy values of the bands decoded by the energy value decoding unit 210 and in consideration of the energy value(s) of the frequency component(s) decoded by the frequency component decoding unit 205. The signal adjustment unit 220 will be described later in greater detail with reference to FIG. 13.

However, the signal adjustment unit 220 may not adjust the signal(s) at the other band(s) that do(es) not contain the frequency component(s) decoded by the frequency component decoding unit 205, from among the signals generated by the signal generation unit 215.

The signal mixing unit 225 may output the result of mixing the signals adjusted by the signal adjustment unit 220 and the frequency component(s) decoded by the frequency component decoding unit 205 with respect to the band(s) containing the decoded frequency component(s), and may output the signals generated by the signal generation unit 215 with respect to the other band(s).

The inverse transformation unit 230 may transform the signal(s) output from the signal mixing unit 225 from the frequency domain to the time domain according to a first predetermined inverse transformation method (which is an inverse operation of the first transformation method performed by the first transformation unit 100 of FIG. 1) and then may output the transformed signal(s) via an output terminal OUT. The first inverse transformation method may be Inverse Modified Discrete Cosine Transformation (IMDCT).

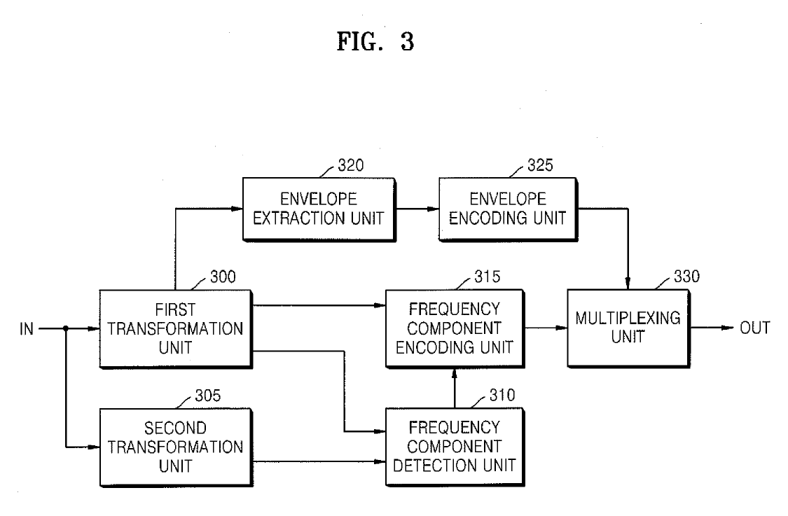

FIG. 3 is a block diagram of an apparatus to encode an audio signal according to another embodiment of the present general inventive concept. The encoding apparatus may include a first transformation unit 300, a second transformation unit 305, a frequency component detection unit 310, a frequency component encoding unit 315, an envelope extracting unit 320, an envelope encoding unit 325, and a multiplexing unit 330.

The first transformation unit 300 may transform an audio signal received via an input terminal IN from the time domain to the frequency domain according to a first predetermined transformation method. The audio signal may be a speech signal or a music signal.

The second transformation unit 305 may transform the received audio signal from the time domain to the frequency domain by using a second transformation method that is different to the first transformation method, in order to apply a psycho acoustic model.

The signal transformed by the first transformation unit 300 may be used to encode the audio signal. The signal transformed by the second transformation unit 305 may be used to detect an important frequency component by applying the psychoacoustic model to the audio signal. The psychoacoustic model refers to a mathematical model regarding a masking reaction of the human auditory system.

For example, the first transformation unit 300 may represent the audio signal with real numbers by transforming it into the frequency domain by using MDCT as the first transformation method, and the second transformation unit 105 may represent the audio signal with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Thus, since phase information of the audio signal can be further represented, DFT may be performed on a signal corresponding to the time domain and then MDCT coefficients may be quantized, thereby preventing a mismatch from occurring.

The frequency component detection unit 310 may detect one or more important frequency components from the signal transformed by the first transformation unit 300 according to predetermined criteria, by using the signal transformed by the second transformation unit 305. In this case, the frequency component detection unit 310 may use various methods in order to detect important frequency components. First, the SMR of a signal may be calculated and then the signal may be determined as an important frequency component if the SMR is greater than a reciprocal number of a masking value. Second, whether a frequency component is important may be determined by extracting a spectrum peak in consideration of a predetermined weight. Third, the SNR of each of sub bands may be calculated, and then frequency components from among sub bands having a small SNR, which have a peak value equal to or greater than a predetermined value, may be determined as important frequency components. The above three methods may be individually performed, or one or a combination of at least two of the three methods may be performed. The above three methods are just examples and thus the present general inventive concept is not limited thereto.

The frequency component encoding unit 315 may encode the frequency component(s) detected by the frequency component detection unit 310, and information representing the location(s) of the frequency component(s).

The envelope extracting unit 320 may extract an envelope of the signal transformed by the first transformation unit 300.

The envelope encoding unit 325 may encode the envelope extracted by the envelope extracting unit 320.

The multiplexing unit 330 may multiplex into a bitstream the frequency component(s) and the information representing the location(s) of the frequency component(s) that may be encoded by the frequency component encoding unit 315 and the envelope encoded by the envelope encoding unit 325 and then may output the bitstream via the output terminal OUT.

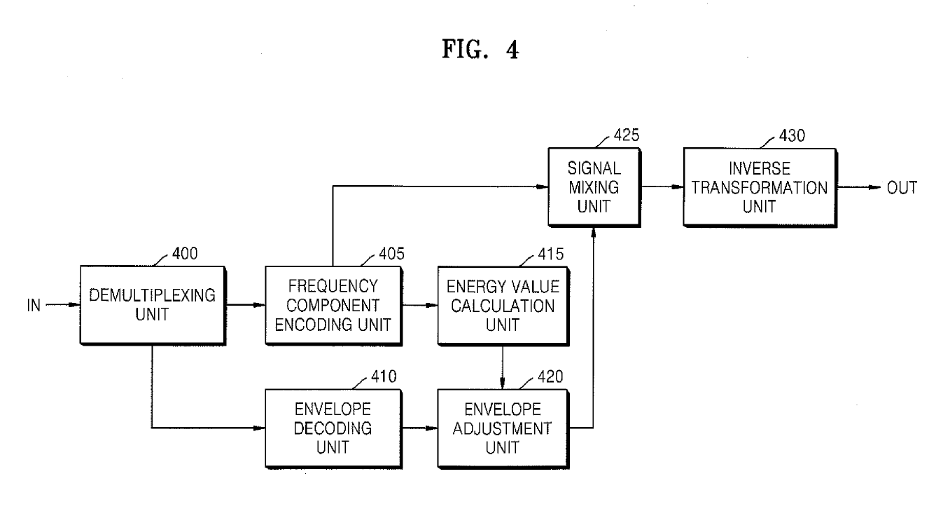

FIG. 4 is a block diagram of an apparatus to decode an audio signal according to an embodiment of the present general inventive concept. The decoding apparatus may include a demultiplexing unit 400, a frequency component decoding unit 405, an envelope decoding unit 410, an energy calculation unit 415, an envelope adjustment unit 420, a signal mixing unit 425, and an inverse transformation unit 430.

The demultiplexing unit 400 may receive a bitstream from an encoding terminal via an input terminal IN and then may demultiplex the bitstream. For example, the demultiplexing unit 400 may demultiplex the bitstream into one or more frequency components, information representing location(s) of the frequency component(s), and an envelope encoded by an encoding apparatus (not shown).

The frequency component decoding unit 405 may decode a frequency component(s) that may be determined as an important frequency component(s) according to predetermined criteria and thus encoded by the encoding apparatus.

The envelope decoding unit 410 may decode envelopes encoded by the encoding apparatus.

The energy calculation unit 415 may calculate an energy value of the frequency component(s) decoded by the frequency component decoding unit 405.

The envelope adjustment unit 420 may adjust one or more signals at one or more bands containing the frequency component(s) decoded by the frequency component decoding unit 405, from among the envelopes decoded by the envelope decoding unit 410. Here, the envelope adjustment unit 420 may perform envelope adjustment so that an energy value of the decoded envelope at each band may be equal to a value obtained by subtracting the energy value of each of the frequency component(s) contained in the bands from the energy value of an envelope at each of the bands containing the frequency component(s) decoded by the frequency component decoding unit 405.

However, the envelope adjustment unit 420 may not adjust the signal(s) at the other bands that do not contain the frequency component(s) decoded by the frequency component decoding unit 405, from among the envelopes decoded by the envelope decoding unit 415.

The signal mixing unit 425 may output the result of mixing the frequency component(s) decoded by the frequency component decoding unit 505 and the envelope adjusted by the envelope adjustment unit 420 with respect to the band(s) containing the decoded frequency component(s), and may output signals decoded by the envelope decoding unit 410 with respect to the other bands.

The inverse transformation unit 430 may transform the signal(s) output from the signal mixing unit 425 from the frequency domain to the time domain according to a first predetermined inverse transformation method (which is an inverse operation of the first transformation method performed by the first transformation unit 300 of FIG. 3) and then may output the transformed signal(s) via an output terminal OUT. The first inverse transformation method may be Inverse Modified Discrete Cosine Transformation (IMDCT).

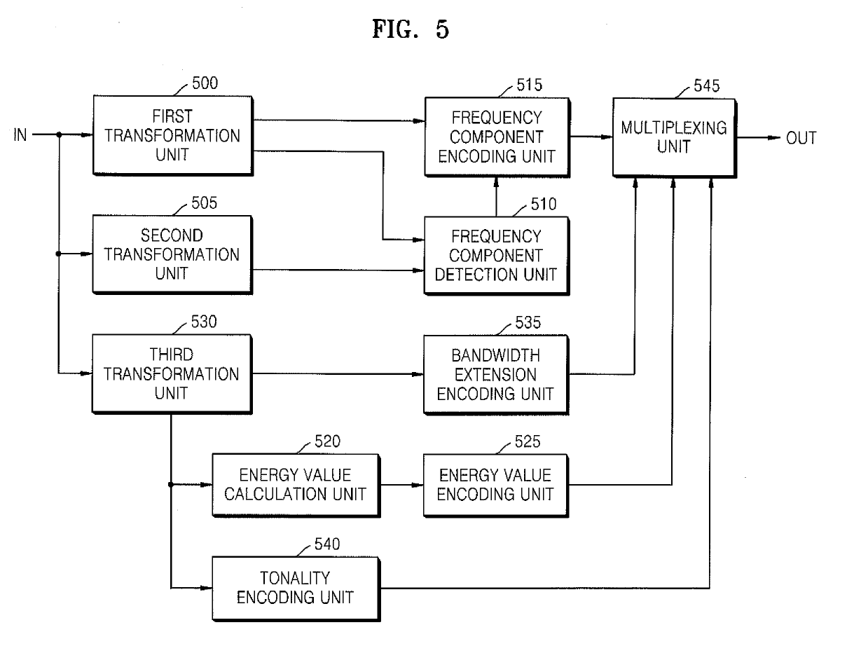

FIG. 5 is a block diagram of an apparatus to encode an audio signal according to an embodiment of the present general inventive concept. The apparatus may include a first transformation unit 500, a second transformation unit 505, a frequency component detection unit 510, a frequency component encoding unit 515, an energy value calculation unit 520, an energy value encoding unit 525, a third transformation unit 530, a bandwidth extension encoding unit 535, a tonality encoding unit 540, and a multiplexing unit 545.

The first transformation unit 500 may transform an audio signal received via an input terminal IN from the time domain to a frequency domain, by using a first predetermined transformation method. Examples of the audio signal are a speech signal and a music signal.

The second transformation unit 505 may transform the received audio signal from the time domain to the frequency domain by using a second transformation method that is different to the first transformation method, in order to apply a psycho acoustic model.

The signal transformed by the first transformation unit 500 may be used to encode the audio signal. The signal transformed by the second transformation unit 505 may be used to detect an important frequency component by applying the psychoacoustic model to the audio signal. The psychoacoustic model refers to a mathematical model regarding a masking reaction of the human auditory system.

For example, the first transformation unit 500 may represent the audio signal with real numbers by transforming it into the frequency domain by using MDCT as the first transformation method, and the second transformation unit 505 may represent the audio signal with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Thus, since phase information of the audio signal can be further represented, DFT may be performed on a signal corresponding to the time domain and then MDCT coefficients may be quantized, thereby preventing a mismatch from occurring.

The frequency component detection unit 510 may detect one or more important frequency components from the signal transformed by the first transformation unit 500 according to predetermined criteria, by using the signal transformed by the second transformation unit 505. In this case, the frequency component detection unit 510 may use various methods in order to detect important frequency components. First, the SMR of a signal may be calculated and then the signal may be determined as an important frequency component if the SMR is greater than a reciprocal number of a masking value. Second, whether a frequency component is important may be determined by extracting a spectrum peak in consideration of a predetermined weight. Third, the SNR of each of sub bands may be calculated, and then frequency components from among sub bands having a small SNR, which have a peak value equal to or greater than a predetermined value, may be determined as important frequency components. The above three methods may be individually performed, or one or a combination of at least two of the three methods may be performed. The above three methods are just examples and thus the present general inventive concept is not limited thereto.

The frequency component encoding unit 515 may encode the frequency component(s) detected by the frequency component detection unit 510, and information representing location(s) of the frequency component(s).

The energy value calculation unit 520 may calculate energy value(s) of a signal (or signals) at either the band(s) containing the frequency component(s) encoded by the frequency component encoding unit 515 or a band (or bands) corresponding to a frequency band less than a predetermined frequency. Here, each of the bands may be a sub band or a scale factor band in the case of a QMF.

The energy value encoding unit 525 may encode the energy values of the bands calculated by the energy value calculation unit 520, and information representing locations of the bands.

The third transformation unit 530 may perform domain transformation on the received audio signal by using an analysis filterbank so that the signal can be represented in the time domain in predetermined frequency band units. For example, the third transformation unit 530 may perform domain transformation using a QMF.

The bandwidth extension encoding unit 535 may encode a signal deformed by the third transformation unit 530, which corresponds to a frequency band greater than a predetermined frequency from among the band(s) containing the frequency component(s) detected by the frequency component detection unit 510, by using a low-frequency signal corresponding to a frequency band less than the predetermined frequency. For the encoding, information to decode a signal (or signals) at a frequency band (or bands) greater than the predetermined frequency by using the low-frequency signal may be encoded.

The tonality encoding unit 540 may calculate a tonality of a signal (or signals) at the band(s) containing the frequency component(s) detected by the frequency component detection unit 515, which may be transformed by the first transformation unit 500, and then may encode the tonality. The tonality encoding unit 540 is not indispensable to the present general inventive concept but may be needed when a decoding apparatus (not shown) generates a signal at the band(s) containing the frequency component(s) by using a plurality of signals rather than a single signal. For example, the tonality encoding unit 540 may be needed if the decoding apparatus generates at the band(s) containing the frequency component(s) by using both a signal that is randomly generated and a patched signal.

The multiplexing unit 545 may multiplex into a bitstream the frequency component(s) and the information representing the location(s) of the frequency component(s) that may be encoded by the frequency component encoding unit 515, the energy value of each band and the information representing the location of each band that may be encoded by the energy value encoding unit 525, and the information to decode a signal at a band that does not contain the frequency component(s) from among frequency bands greater than the predetermined frequency (the information being generated from the low-frequency signal and encoded by the bandwidth extension encoding unit 535), and then may output the bitstream via an output terminal OUT. Alternatively, the tonality (or tonalities) decoded by the tonality encoding unit 540 may also be multiplexed into the bitstream.

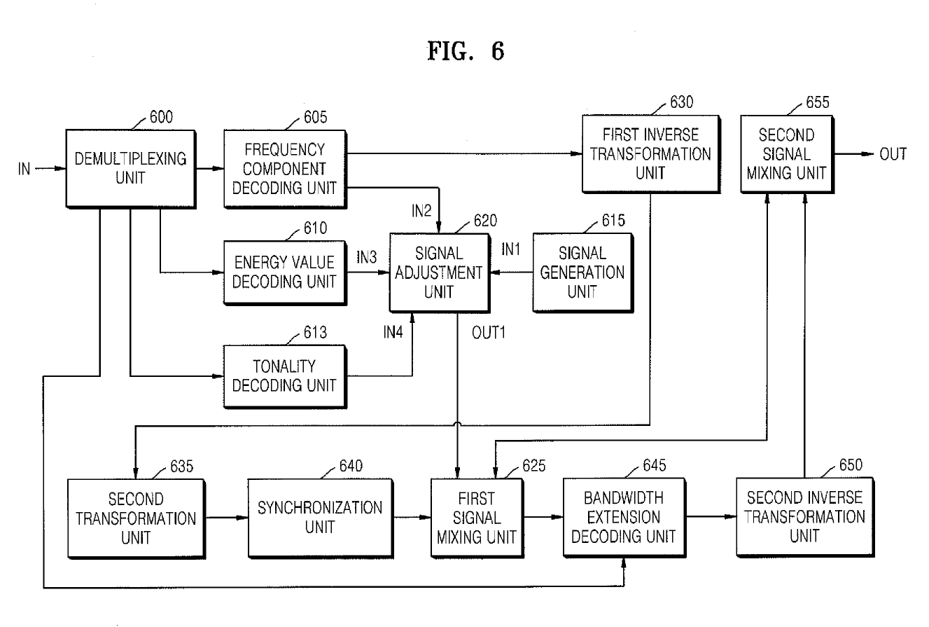

FIG. 6 is a block diagram of an apparatus to decode an audio signal according to an embodiment of the present general inventive concept. The apparatus may include a demultiplexing unit 600, a frequency component decoding unit 605, an energy value decoding unit 610, a tonality decoding unit 613, a signal generation unit 615, a signal adjustment unit 620, a first signal mixing unit 625, a first inverse transformation unit 630, a second transformation unit 635, a synchronization unit 640, a bandwidth extension decoding unit 645, a second inverse transformation unit 650, and a second signal mixing unit 655.

The demultiplexing unit 600 may receive a bitstream from an encoding terminal via an input terminal IN and then may demultiplex the bitstream. For example, the demultiplexing unit 600 may demultiplex the bitstream into one or more frequency components, information representing location(s) of the frequency component(s), energy values of bands, information representing locations of the bands encoded by an encoding apparatus (not shown), information to decode a signal (or signals) at a band (or bands) that do(es) not contain the frequency component(s) from among frequency bands greater than a predetermined frequency by using a signal corresponding to a frequency band less than the predetermined frequency, and a tonality (or tonalities).

The frequency component decoding unit 605 may decode one or more predetermined frequency components that were determined as important frequency components according to predetermined criteria and then encoded by the encoding apparatus.

The energy value decoding unit 610 may decode the energy value of a signal(s) at either the band(s) containing the frequency component(s) decoded by the frequency component decoding unit 605 or a frequency band less than a predetermined frequency.

The tonality decoding unit 613 may decode a tonality of the signal(s) at the band(s) containing the frequency component(s) decoded by frequency component decoding unit 605. However, the tonality decoding unit 613 is not indispensable to the present general inventive concept but may be needed when the signal generation unit 615 generates a signal from a plurality of signals, rather than from a single signal. For example, the tonality decoding unit 613 may be needed for the signal generating unit 615 to generate one or more signals at the band(s) containing the frequency component(s) decoded by the frequency component decoding unit 605 by using both a signal being arbitrarily generated and a patched signal. If the tonality decoding unit 613 is included in the present general inventive concept, the signal adjustment unit 620 may adjust the signal generated by the signal generation unit 615 in consideration of the tonality decoded by the tonality decoding unit 613.

The signal generation unit 615 may generate a signal (or signals) having the energy value(s) of either the band(s) containing the frequency component(s) decoded by the energy value decoding unit 610 or of the frequency band(s) less than the predetermined frequency, at the bands.

The signal generation unit 615 may use various methods in order to generate signals. First, the signal generation unit 615 may arbitrarily generate a noise signal, e.g., a random noise signal. Second, if a signal at a predetermined band is a high-frequency signal corresponding to a frequency band greater than a predetermined frequency and a low-frequency signal corresponding to a frequency band less than the predetermined frequency has already been decoded and thus is available, the signal generation unit 615 may generate a signal by duplicating the low-frequency signal. For example, a signal may be generated by patching or folding a signal at a low frequency band.

The signal adjustment unit 620 may adjust a signal or signals at the band(s) containing the frequency component(s) decoded by the frequency component decoding unit 605, from among the signal(s) generated by the signal generation unit 615. In detail, the signal adjustment unit 620 may adjust the signal(s) generated by the signal generation unit 620 so that the energy values of the signal(s) can be adjusted, based on the energy value(s) at the band(s) decoded by the energy value decoding unit 610 and in consideration of the energy value(s) of the frequency component(s) decoded by the frequency component decoding unit 605. The signal adjustment unit 620 will be described later in greater detail with reference to FIG. 13.

The first signal mixing unit 625 may output the result of mixing the signals adjusted by the signal adjustment unit 620 and the frequency component(s) decoded by the frequency component decoding unit 605 with respect to the band(s) containing the decoded frequency component(s), and may output the signals generated by the signal generation unit 615 with respect to frequency bands less than a predetermined frequency from among the other band(s) that do(es) not contain the decoded frequency component(s).

The inverse transformation unit 630 may transform the signal(s) output from the signal mixing unit 625 from the frequency domain to the time domain according to a first predetermined inverse transformation method (which is an inverse operation of the first transformation method performed by the first transformation unit 500 of FIG. 5). The first inverse transformation method may be IMDCT.

The second transformation unit 635 may perform domain transformation on the signal(s) being inversely transformed by the first inverse transformation unit 630 so that the signal(s) can be represented in the time domain in units of predetermined frequency bands, by using an analysis filterbank. For example, the second transformation unit 635 may perform domain transformation using a QMF.

If frames applied to the frequency component decoding unit 605 are not the same as those applied to the bandwidth extension decoding unit 645, the synchronization unit 640 synchronizes the frames applied to the frequency component decoding unit 605 with those applied to the bandwidth extension decoding unit 645. Here, the synchronization unit 640 may process all or some of the frames applied to the bandwidth extension decoding unit 645, based on the frames applied to the frequency component decoding unit 605.

The bandwidth extension decoding unit 645 may decode a signal(s) at a band that does not contain the frequency component(s) decoded by the frequency component decoding unit 605 from among frequency bands greater than the predetermined frequency, by using a signal or signals corresponding to a frequency band less than a predetermined frequency from among the signal(s) transformed by the second transformation unit 635. For the decoding, the bandwidth extension decoding unit 645 uses the demultiplexed information to decode a signal at a frequency band greater than the predetermined frequency by using a signal at a frequency band less than the predetermined frequency.

The second inverse transformation unit 650 may perform inverse transformation on the domain of the signal(s) decoded by the bandwidth extension decoding unit 645 by using a synthesis filterbank, where the inverse transformation may be an inversion operation of the transformation performed by the second transformation unit 635.

The second signal mixing unit 655 may mix the signal(s) being inversely transformed by the first inverse transformation unit 630 and the signal(s) being inversely transformed by the second inverse transformation unit 650. The signal(s) being inversely transformed by the first inverse transformation unit 630 may include the signal(s) at the band(s) containing the frequency component(s) decoded by the frequency component decoding unit 605, and the signal(s) at the frequency band(s) less than the predetermined frequency from among the other bands that do not contain the decoded frequency component(s). Also, the signal(s) being inversely transformed by the second inverse transformation unit 650 may include the signal(s) at the frequency band(s) greater than the predetermined frequency from among the band(s) that do(es) not contain the decoded frequency component(s). Accordingly, the second signal mixing unit 655 can restore audio signals of the whole frequency band and output the restored signals via an output terminal OUT.

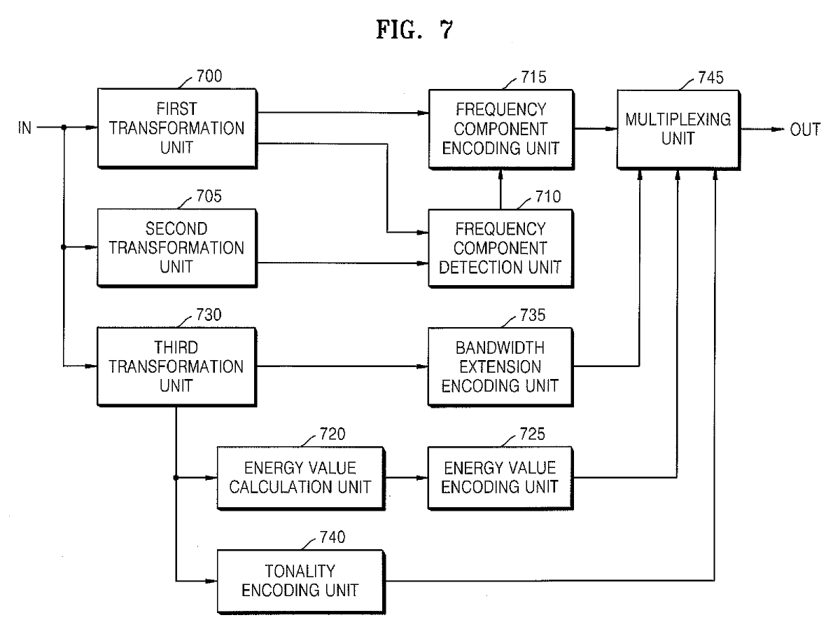

FIG. 7 is a block diagram of an apparatus to encode an audio signal according to an embodiment of the present general inventive concept. The apparatus may include a first transformation unit 700, a second transformation unit 705, a frequency component detection unit 710, a frequency component encoding unit 715, an energy value calculation unit 720, an energy value encoding unit 725, a third transformation unit 730, a bandwidth extension encoding unit 735, a tonality encoding unit 740, and a multiplexing unit 745.

The first transformation unit 700 may transform an audio signal received via an input terminal IN from the time domain to a frequency domain, by using a first predetermined transformation method. Examples of the audio signal are a speech signal and a music signal.

The second transformation unit 705 may transform the received audio signal from the time domain to the frequency domain by using a second transformation method that is different to the first transformation method, in order to apply a psycho acoustic model.

The signal transformed by the first transformation unit 700 may be used to encode the audio signal. The signal transformed by the second transformation unit 705 may be used to detect an important frequency component by applying the psychoacoustic model to the audio signal. The psychoacoustic model refers to a mathematical model regarding a masking reaction of the human auditory system.

For example, the first transformation unit 700 may represent the audio signal with real numbers by transforming it into the frequency domain by using MDCT as the first transformation method, and the second transformation unit 705 may represent the audio signal with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Thus, since phase information of the audio signal can be further represented, DFT may be performed on a signal corresponding to the time domain and then MDCT coefficients may be quantized, thereby preventing a mismatch from occurring.

The frequency component detection unit 710 may detect one or more important frequency components from the signal transformed by the first transformation unit 700 according to predetermined criteria, by using the signal transformed by the second transformation unit 105. In this case, the frequency component detection unit 110 may use various methods in order to detect important frequency components. First, the SMR of a signal may be calculated and then the signal may be determined as an important frequency component if the SMR is greater than a reciprocal number of a masking value. Second, whether a frequency component is important may be determined by extracting a spectrum peak in consideration of a predetermined weight. Third, the SNR of each of sub bands may be calculated, and then frequency components from among sub bands having a small SNR, which have a peak value equal to or greater than a predetermined value, may be determined as important frequency components. The above three methods may be individually performed, or one or a combination of at least two of the three methods may be performed. The above three methods are just examples and thus the present general inventive concept is not limited thereto.

The frequency component encoding unit 715 may encode the frequency component(s) detected by the frequency component detection unit 710, and information representing location(s) of the frequency component(s).

The energy value calculation unit 720 may calculate an energy value of a signal (or signals) at a frequency band (or bands) less than a predetermined frequency. Here, each of the bands may be a sub band or a scale factor band in the case of a QMF.

The energy value encoding unit 725 may encode the energy values of the bands calculated by the energy value calculation unit 720 and information representing locations of the bands.

The third transformation unit 730 may perform domain transformation on the received audio signal by using the analysis filterbank so that the audio signal can be represented in the time domain in predetermined frequency band units. For example, the third transformation unit 730 may perform domain transformation using the QMF.

The bandwidth extension encoding unit 735 may encode a high-frequency signal corresponding to a frequency band greater than the predetermined frequency from among signals transformed by the third transformation unit 730 by using a low-frequency signal corresponding to a frequency band less than the predetermined frequency. For the encoding, information to decode a signal having a frequency band greater than a second frequency by using the low-frequency signal may be generated and encoded.

The tonality encoding unit 740 may calculate and encode a tonality of a signal or signals of the band(s) that contain(s) the frequency component(s) detected by the frequency component detection unit 715. The tonality encoding unit 740 is not indispensable to the present general inventive concept but may be needed when a decoding apparatus (not shown) generates a signal from a plurality of signals, rather than a single signal, at the band(s) having the frequency component(s). For example, the tonality encoding unit 740 may be needed for the decoding apparatus to generate one or more signals at the band(s) having the frequency component(s) by using both a signal being arbitrarily generated and a patched signal.

The multiplexing unit 745 may multiplex into a bitstream all the frequency component(s) and the information representing the location(s) of the frequency component(s) that may be encoded by the frequency component encoding unit 715, the energy values of the bands and the information representing the locations of the bands that may be encoded by the energy value encoding unit 725, and the information to decode a high-frequency signal using a low-frequency signal, which may be encoded by the bandwidth extension encoding unit 735, and then may output the bitstream via an output terminal OUT. Alternatively, the tonality (or tonalities) encoded by the tonality encoding unit 740 may also be multiplexed into the bitstream.

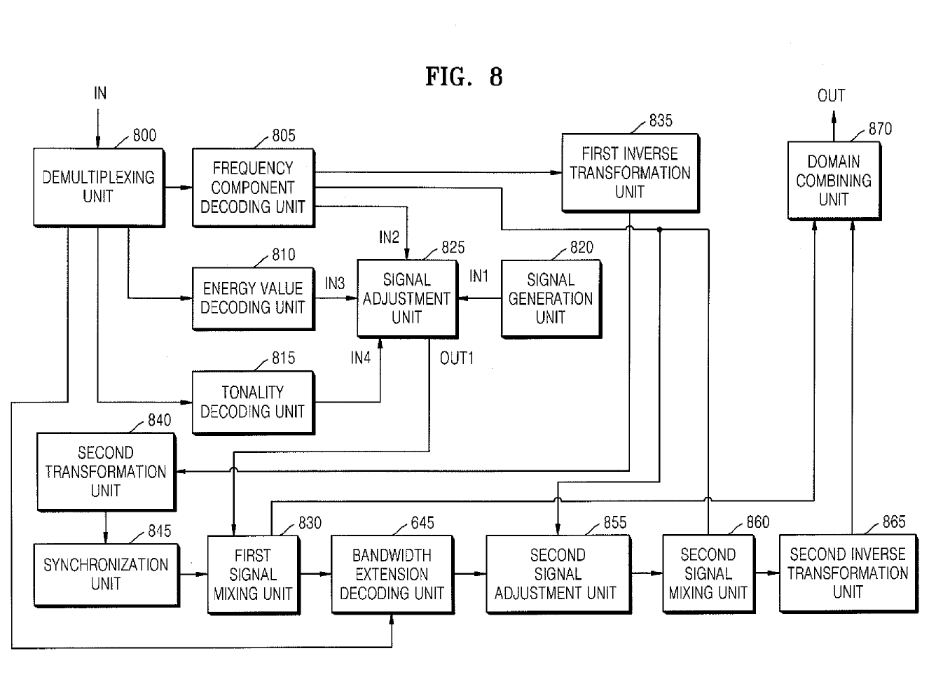

FIG. 8 is a block diagram of an apparatus to decode an audio signal according to another embodiment of the present general inventive concept. The decoding apparatus may include a demultiplexing unit 800, a frequency component decoding unit 805, an energy value decoding unit 810, a tonality decoding unit 815, a signal generation unit 820, a first signal adjustment unit 825, a first signal mixing unit 830, a first inverse transformation unit 835, a second transformation unit 840, a synchronization unit 845, a bandwidth extension encoding unit 850, a second signal adjustment unit 855, a second signal mixing unit 860, a second inverse transformation unit 865, and a domain combining unit 870.

The demultiplexing unit 800 may receive a bitstream from an encoding terminal via an input terminal IN and then may demultiplex the bitstream. For example, the demultiplexing unit 800 may demultiplex the bitstream into one or more frequency components, information representing location(s) of the frequency component(s), an energy value of each band, information representing location(s) of the band(s) whose energy value(s) may be encoded by an encoding apparatus (not shown), information to decode a signal having a frequency band greater than a predetermined frequency by using a signal having a frequency band less than the predetermined frequency, and a tonality (or tonalities) of the signal.

The frequency component decoding unit 805 may decode one or more predetermined frequency components that were determined as important frequency components according to predetermined criteria and then encoded by the encoding apparatus.

The energy value decoding unit 810 may decode the energy value of the band(s) of a low-frequency signal (or signals) having a frequency band (or bands) less than the predetermined frequency.

The tonality decoding unit 815 may decode the tonality (or tonalities) of a signal (or signals) at a band (or bands) containing the frequency component(s) decoded by the frequency component decoding unit 805 from among frequency bands less than the predetermined frequency. However, the tonality decoding unit 815 is not indispensable to the present general inventive concept but may be needed when the signal generation unit 820 generates a signal from a plurality of signals, rather than from a single signal. For example, the tonality decoding unit 815 may be needed for the signal generating unit 820 to generate one or more signals at the band(s) containing the frequency component(s) decoded by the frequency component decoding unit 805 by using both a signal being arbitrarily generated and a patched signal. If the tonality decoding unit 815 is included in the present general inventive concept, the first signal adjustment unit 825 may adjust the signal(s) generated by the signal generation unit 820 in consideration of the tonality (or tonalities) decoded by the tonality decoding unit 815.

The signal generation unit 820 may generate signals each having the energy values of the bands decoded by the energy value decoding unit 810, for each band.

The signal generation unit 820 may use various methods in order to generate signals at the bands. First, the signal generation unit 820 may arbitrarily generate a noise signal, e.g., a random noise signal. Second, if a signal at a predetermined band has already been decoded and thus is available, the signal generation unit 820 may generate a signal by duplicating the decoded signal. For example, a signal may be generated by patching or folding the decoded signal.

The first signal adjustment unit 825 may adjust a signal or signals at a band or bands that contain the frequency component(s) decoded by the frequency component decoding unit 804 from among frequency bands less than a predetermined frequency, from among the signal(s) generated by the signal generation unit 820. Here, the first signal adjustment unit 825 may adjust the signal(s) generated by the signal generation unit 820 so that the energy values of the signal(s) can be adjusted, based on the energy value of each band decoded by the energy value decoding unit 810 and in consideration of the energy value(s) of the frequency component(s) decoded by the frequency component decoding unit 805. The first signal adjustment unit 825 will be described later in greater detail with reference to FIG. 13.

The first signal mixing unit 830 may output the result of mixing the frequency component(s) decoded by the frequency component decoding unit 805 and the signal(s) adjusted by the first signal adjustment unit 825 at the band(s) containing the decoded frequency component(s) from among the frequency bands less than the predetermined frequency, and may output the signal(s) generated by the signal generation unit 810 at the other bands that do not contain the decoded frequency component(s). Thus, the first signal mixing unit 830 can restore a low-frequency signal.

The first inverse transformation unit 835 may perform domain transformation on the low-frequency signal, which was restored by the first signal mixing unit 830, from the frequency domain to the time domain according to a predetermined first inverse transformation method, the domain transformation being an inverse operation of the transformation performed by the first transformation unit 700 of FIG. 7. An example of the first inverse transformation method is IMDCT.

The second transformation unit 840 may perform domain transformation on the low-frequency signal, which was inversely transformed by the first inverse transformation unit 835, by using an analysis filterbank so that this signal can be represented in the time domain in predetermined frequency band units. For example, the second transformation unit 840 may perform domain transformation by applying a QMF.

If frames applied to the frequency component decoding unit 805 are not the same as those applied to the bandwidth extension decoding unit 850, the synchronization unit 840 synchronizes the frames applied to the frequency component decoding unit 805 with those applied to the bandwidth extension decoding unit 850. Here, the synchronization unit 845 may process all or some of the frames applied to the bandwidth extension decoding unit 850, based on the frames applied to the frequency component decoding unit 805.

The bandwidth extension decoding unit 850 may decode a high-frequency signal corresponding to a frequency band greater than a predetermined frequency by using low-frequency signals transformed by the second transformation unit 840. For the decoding, the bandwidth extension decoding unit 850 uses information to decode a high-frequency signal by using the low-frequency signal being demultiplexed by the demultiplexing unit 800.

The second signal adjustment unit 855 may adjust a signal (or signals) at the band(s) containing the frequency component(s) decoded by the frequency component decoding unit 805, from among high-frequency signals decoded by the bandwidth extension decoding unit 850.

First, the second signal adjustment unit 855 may calculate the energy value(s) of a frequency component (or frequency components) at a frequency band (or bands) greater than a predetermined frequency. Also, the second signal adjustment unit 855 may adjust the high-frequency signal decoded by the bandwidth extension decoding unit 850 so that the energy values of a signal (or signals) at a band (or bands) adjusted by the second signal adjustment unit 855 may be equal to a value obtained by subtracting the energy value of the frequency component(s) contained in each band from the energy value of the signal decoded by the bandwidth extension decoding unit 850.

The second signal mixing unit 860 may output the result of mixing the frequency component(s) decoded by the frequency component decoding unit 805 and the signal(s) adjusted by the second signal adjustment unit 855 at a band (or bands) containing the decoded frequency component(s) from among frequency bands greater than a predetermined frequency, and may output the signal(s) decoded by the bandwidth extension decoding unit 850 at the other bands that do not contain the decoded frequency component(s). Thus, the second signal mixing unit 860 can restore a high-frequency signal.

The second inverse transformation unit 865 may perform inverse transformation on the domain of the high-frequency signal restored by the second signal mixing unit 860 by using a synthesis filterbank, the inverse transformation being an inverse operation of the transformation performed by the second transformation unit 840.

The domain combining unit 870 may mix the low-frequency signal being inversely transformed by the first inverse transformation unit 835 and the high-frequency signal being transformed by the second inverse transformation unit 865 and then may output the result of mixing via an output terminal OUT.

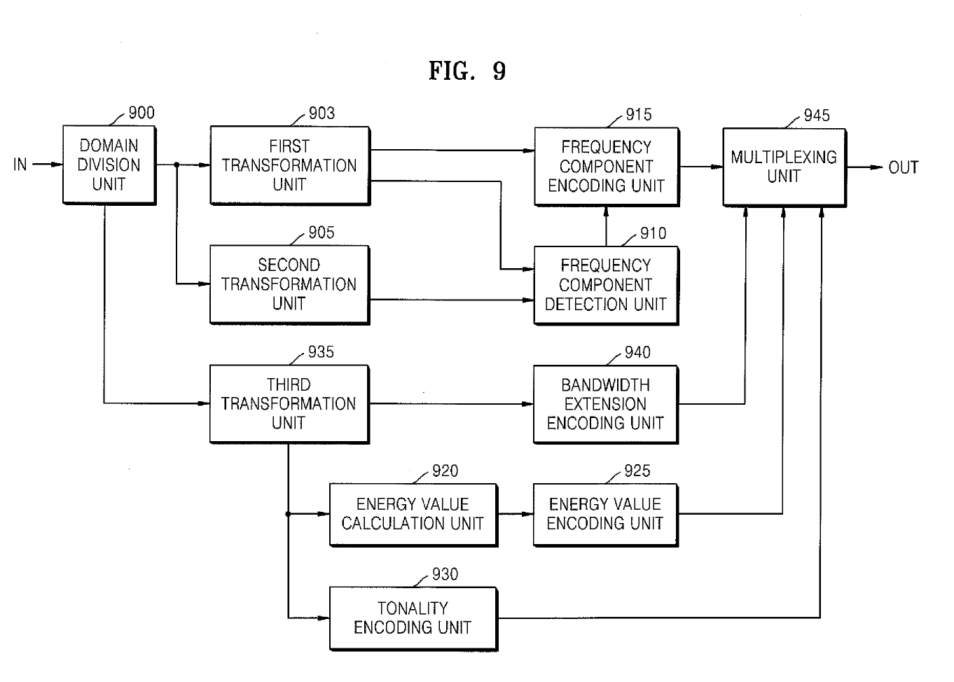

FIG. 9 is a block diagram of an apparatus to encode an audio signal according to another embodiment of the present general inventive concept. The encoding apparatus may include a domain division unit 900, a first transformation unit 903, a second transformation unit 905, a frequency component detection unit 910, a frequency component encoding unit 915, an energy value calculation unit 920, an energy value encoding unit 925, a tonality encoding unit 930, a third transformation unit 935, a bandwidth extension encoding unit 940, and a multiplexing unit 945.

The domain division unit 900 divides a signal received via an input terminal IN into a low-frequency signal and a high-frequency signal, based on a predetermined frequency. Here, the low-frequency signal has a frequency band less than a first frequency and the high-frequency signal has a frequency band greater than a second frequency. In one aspect of the present general inventive concept, the first frequency and the second frequency may be the same frequency, but it is understood the first frequency and the second frequency may also be different from each other.

The first transformation unit 903 may transform the low-frequency signal received from the domain division unit 900 from the time domain to the frequency domain according to a first predetermined transformation method.

The second transformation unit 905 may transform the low-frequency signal from the time domain to the frequency domain according to a second predetermined transformation method different from the first predetermined transformation method, in order to apply a psycho acoustic model.

The signal transformed by the first transformation unit 903 may be used to encode the low-frequency signal. The signal transformed by the second transformation unit 905 may be used to detect one or more important frequency components by applying the psychoacoustic model to the low-frequency signal. The psychoacoustic model refers to a mathematical model regarding a masking reaction of the human auditory system.

For example, the first transformation unit 903 may represent the low-frequency signal with real numbers by transforming it into the frequency domain by using MDCT as the first transformation method, and the second transformation unit 905 may represent the low-frequency signal with imaginary numbers by transforming it into the frequency domain by using MDST as the second transformation method. Here, the signal represented with real numbers as a result of using MDCT may be used to encode the low-frequency signal, and the signal represented with imaginary numbers as a result of using MDST may be used to detect important frequency components by applying the psychoacoustic model to the low-frequency signal. Thus, since the phase information of the low-frequency signal can be further represented, DFT may be performed on a signal corresponding to the time domain and then MDCT coefficients may be quantized, thereby preventing a mismatch from occurring.

The frequency component detection unit 910 may detect one or more important frequency components from among low-frequency signals transformed by the first transformation unit 100 according to predetermined criteria, by using the signal transformed by the second transformation unit 105. In this case, the frequency component detection unit 910 may use various methods in order to detect important frequency components. First, the SMR of a signal may be calculated and then the signal may be determined as an important frequency component if the SMR is greater than a reciprocal number of a masking value. Second, whether a frequency component is important may be determined by extracting a spectrum peak in consideration of a predetermined weight. Third, the SNR of each of sub bands may be calculated, and then frequency components having a peak value equal to or greater than a predetermined value from among sub bands having a small SNR may be determined as important frequency components. The above three methods may be individually performed, or one or a combination of at least two of the three methods may be performed. The above three methods are just examples and thus the present general inventive concept is not limited thereto.

The frequency component encoding unit 915 may encode the frequency component(s) of the low-frequency signal detected by the frequency component detection unit 910, and information representing location(s) of the frequency component(s).

The energy value calculation unit 920 may calculate an energy value of a signal at each band of the low-frequency signal transformed by the first transformation unit 903. Here, each of the bands may be a sub band or a scale factor band in the case of a QMF.

The energy value encoding unit 925 may encode the energy value of each band calculated by the energy value calculation unit 920 and information representing locations of the bands.

The tonality encoding unit 930 may calculate and encode a tonality of a signal (or signals) of the band(s) that contain(s) the frequency component(s) detected by the frequency component detection unit 910. The tonality encoding unit 930 is not indispensable to the present general inventive concept but may be needed when a decoding apparatus (not shown) generates a signal from a plurality of signals, rather than a single signal, at the band(s) having the frequency component(s). For example, the tonality encoding unit 930 may be needed for the decoding apparatus to generate one or more signals at the band(s) having the frequency component(s) by using both a signal being arbitrarily generated and a patched signal.

The third transformation unit 935 may perform domain transformation on the high-frequency signal received from the domain division unit 900 by using the analysis filterbank so that this signal can be represented in the time domain in predetermined frequency band units. For example, the third transformation unit 935 may perform domain transformation by applying the QMF.

The bandwidth extension encoding unit 940 may encode the high-frequency signal transformed by the third transformation unit 730, by using the low-frequency signal. For the encoding, information to decode the high-frequency signal by using the low-frequency signal may be generated and encoded.

The multiplexing unit 945 may multiplex into a bitstream all the frequency component(s) and the information representing the location(s) of the frequency component(s) that may be encoded by the frequency component encoding unit 915, the energy values of the bands and the information representing the locations of the bands that may be encoded by the energy value encoding unit 925, and the information to encode the high-frequency signal by using the low-frequency signal, which may be encoded by the bandwidth extension encoding unit 940, and then may output the bitstream via an output terminal OUT. Alternatively, the tonality (or tonalities) encoded by the tonality encoding unit 930 may also be multiplexed into the bitstream.

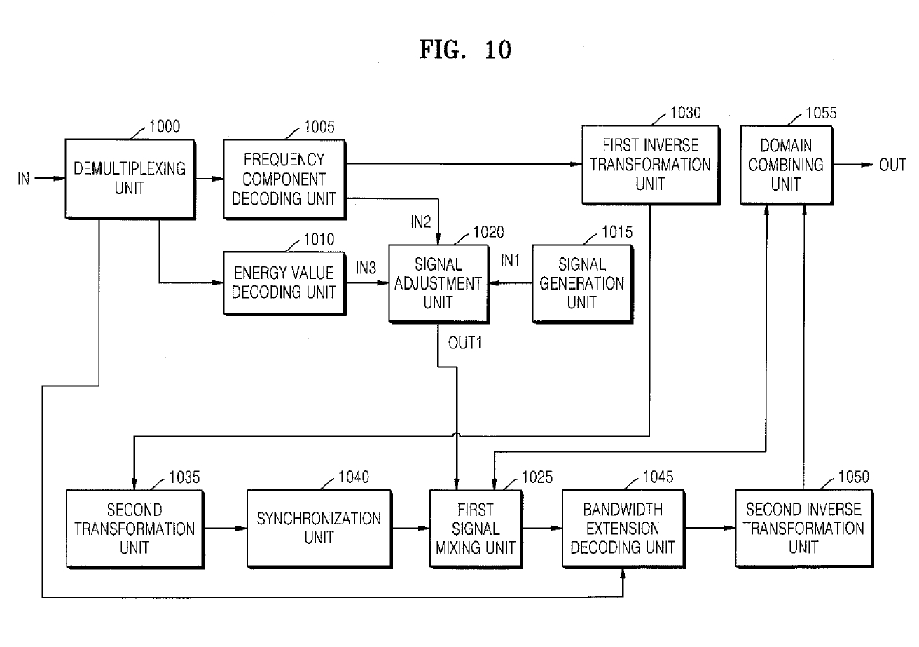

FIG. 10 is a block diagram of an apparatus to decode an audio signal according to another embodiment of the present general inventive concept. The decoding apparatus may include a demultiplexing unit 1000, a frequency component decoding unit 1005, an energy value decoding unit 1010, a signal generation unit 1015, a signal adjustment unit 1020, a signal mixing unit 1025, a first inverse transformation unit 1030, a second transformation unit 1035, a synchronization unit 1040, a bandwidth extension decoding unit 1045, a second inverse transformation unit 1050, and a domain combining unit 1055.

The demultiplexing unit 1000 may receive a bitstream from an encoding terminal via an input terminal IN and then may demultiplex the bitstream. For example, the demultiplexing unit 1000 may demultiplex the bitstream into one or more frequency components, information representing location(s) of the frequency component(s), the energy values of bands, information representing locations of the bands whose energy values may be encoded by an encoding apparatus (not shown), information to encode a high-frequency signal by using a low-frequency signal, and a tonality (or tonalities) of the signal.

The frequency component decoding unit 1005 may decode one or more predetermined frequency components that were determined as important frequency components according to predetermined criteria and then encoded by the encoding apparatus with respect to a low-frequency signal having a frequency band less than a predetermined frequency.

The energy value decoding unit 1010 may decode the energy value of a signal at each of frequency bands less the predetermined frequency.

The signal generation unit 1015 may generate signals each having the energy values of the bands decoded by the energy value decoding unit 1010, for each band.

The signal generation unit 1015 may use various methods in order to generate signals. First, the signal generation unit 1015 may arbitrarily generate a noise signal, e.g., a random noise signal. Second, if a signal at a predetermined band is a signal corresponding to high-frequency band and a signal corresponding to a low-frequency band has already been decoded and thus is available, the signal generation unit 1015 may generate a signal by duplicating the signal corresponding to the low-frequency band. For example, a signal may be generated by patching or folding the signal corresponding to the low-frequency band.

The signal adjustment unit 1020 may adjust a signal (or signals) at the band(s) containing the frequency component(s) decoded by the frequency component decoding unit 1005, from among the signal(s) generated by the signal generation unit 1015. Here, the signal adjustment unit 1020 may adjust the signal(s) generated by the signal generation unit 1020 so that the energies of the signals can be adjusted based on the energy values of the bands decoded by the energy value decoding unit 1010 and in consideration of the energy value(s) of the frequency component(s) decoded by the frequency component decoding unit 1005. The signal adjustment unit 1020 will be described later in greater detail with reference to FIG. 13.

However, the signal adjustment unit 1020 may not adjust the other signals at the band(s) that do(es) not contain the frequency component(s) decoded by the frequency component decoding unit 1005, from among the signals generated by the signal generation unit 1015.

The signal mixing unit 1025 may output the result of mixing the frequency component(s) decoded by the frequency component decoding unit 1005 and the signals adjusted by the signal adjustment unit 1020 with respect to a band or bands containing the decoded frequency component(s) from among frequency bands less than a predetermined frequency, and may output the signals generated by the signal generation unit 1015 with respect to the other band(s) that do(es) not contain the decoded frequency component(s). Accordingly, the signal mixing unit 1025 can restore a low-frequency signal.

The first inverse transformation unit 1030 may transform the low-frequency signal(s) output from the signal mixing unit 1025 from the frequency domain to the time domain according to a first predetermined inverse transformation method (which may be an inverse operation of the transformation performed by the first transformation unit 903 of FIG. 9). The first inverse transformation method may be IMDCT.

The second transformation unit 1035 may perform domain transformation on the low-frequency signal(s), which was (or were) inversely transformed by the first inverse transformation unit 1030, by using an analysis filterbank so that the signal(s) can be represented in the time domain in predetermined frequency band units. For example, the second transformation unit 1035 may perform domain transformation by applying a QMF.

If frames applied to the frequency component decoding unit 1005 are not the same as those applied to the bandwidth extension decoding unit 1045, the synchronization unit 1040 synchronizes the frames applied to the frequency component decoding unit 1005 with those applied to the bandwidth extension decoding unit 1045. Here, the synchronization unit 1040 may process all or some of the frames applied to the bandwidth extension decoding unit 1045, based on the frames applied to the frequency component decoding unit 1005.

The bandwidth extension decoding unit 1045 may decode a high-frequency signal by using the low-frequency signal being transformed by the second transformation unit 1035. For the decoding, information to decode the high-frequency signal by using the low-frequency signal being demultiplexed by the demultiplexing unit 1000, may be used.

The second inverse transformation unit 1050 inversely may transform the domain of the high-frequency signal decoded by the bandwidth extension decoding unit 1045 in the reverse manner that transformation is performed by the second transformation unit 1035, by using a synthesis filterbank.

The domain combining unit 1055 may mix the low-frequency signal being inversely transformed by the first inverse transformation unit 1030 and the high-frequency signal being inversely transformed by the second inverse transformation unit 1050 and then may output the result of mixing via an output terminal OUT.

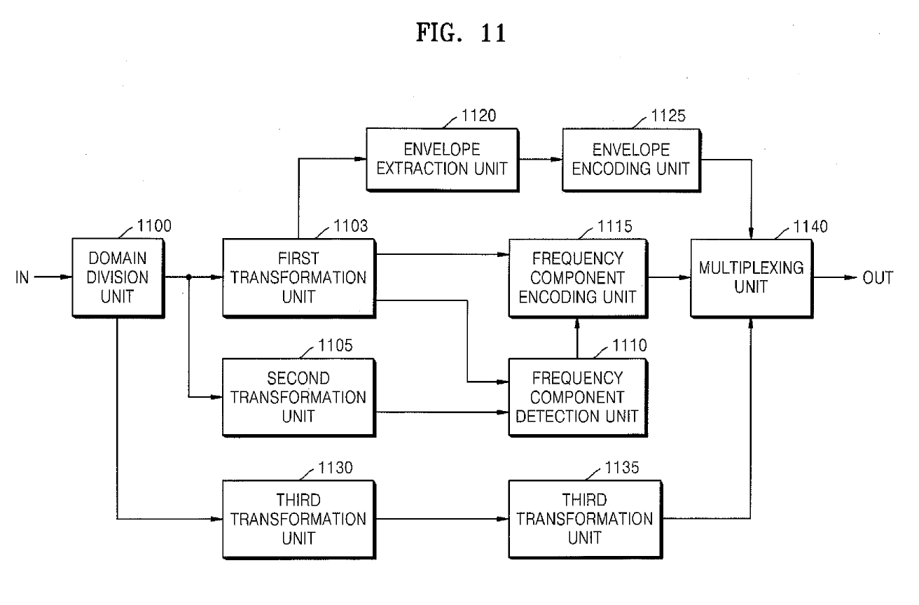

FIG. 11 is a block diagram of an apparatus to encode an audio signal according to another embodiment of the present general inventive concept. The encoding apparatus may include a domain division unit 1100, a first transformation unit 1103, a second transformation unit 1105, a frequency component detection unit 1110, a frequency component encoding unit 1115, an envelope extracting unit 1120, an envelope encoding unit 1125, a third transformation unit 1130, a bandwidth extension encoding unit 1135, and a multiplexing unit 1140.

The domain division unit 1100 divides a signal received via an input terminal IN into a low-frequency signal and a high-frequency signal based on a predetermined frequency. Here, the low-frequency signal has a frequency band less than a predetermined first frequency and the high-frequency signal has a frequency band greater than a predetermined second frequency. In one aspect of the present general inventive concept, the first frequency and the second frequency may be the same, but it is understood the first frequency and the second frequency may also be different from each other.

The first transformation unit 1103 may transform the low-frequency signal received from the domain division unit 1100 from the time domain to a frequency domain, by using a first predetermined transformation method.

The second transformation unit 1105 may transform the received low-frequency signal from the time domain to the frequency domain by using a second transformation method that is different to the first transformation method, in order to apply a psycho acoustic model.

The signal transformed by the first transformation unit 1103 may be used to encode the low-frequency signal. The signal transformed by the second transformation unit 1105 may be used to detect one or more important frequency components by applying the psychoacoustic model to the low-frequency signal. The psychoacoustic model refers to a mathematical model regarding a masking reaction of the human auditory system.

For example, the first transformation unit 1103 may represent the low-frequency signal with real numbers by transforming it into the frequency domain by using MDCT as the first transformation method, and the second transformation unit 1105 may represent the low-frequency signal with imaginary numbers by transforming it into the frequency domain by using MDST as the second transformation method. Here, the signal represented with real numbers as a result of using MDCT may be used to encode the low-frequency signal, and the signal represented with imaginary numbers as a result of using MDST may be used to detect important frequency components by applying the psychoacoustic model to the low-frequency signal. Thus, since the phase information of the low-frequency signal can be further represented, DFT may be performed on a signal corresponding to the time domain and then MDCT coefficients may be quantized, thereby preventing a mismatch from occurring.

The frequency component detection unit 1110 may detect one or more important frequency components from low-frequency signals transformed by the first transformation unit 1103 according to predetermined criteria, by using the signal transformed by the second transformation unit 1105. In this case, the frequency component detection unit 1110 may use various methods in order to detect important frequency components. First, the SMR of a signal may be calculated and then the signal may be determined as an important frequency component if the SMR is greater than a reciprocal number of a masking value. Second, whether a frequency component is important may be determined by extracting a spectrum peak in consideration of a predetermined weight. Third, the SNR of each of sub bands may be calculated, and then frequency components having a peak value equal to or greater than a predetermined value from among sub bands having a small SNR may be determined as important frequency components. The above three methods may be individually performed, or one or a combination of at least two of the three methods may be performed. The above three methods are just examples and thus the present general inventive concept is not limited thereto.

The frequency component encoding unit 1115 may encode the frequency component(s) detected by the frequency component detection unit 1110, and information representing location(s) of the frequency component(s).

The envelope extracting unit 1120 may extract an envelope of the low-frequency signal transformed by the first transformation unit 1103.

The envelope encoding unit 1125 may encode the envelope of the low-frequency signal that was extracted by the envelope extracting unit 1120.

The third transformation unit 1130 may perform domain transformation on the high-frequency signal, which may be received from the domain division unit 1100, by using an analysis filterbank so that this signal can be represented in the time domain in predetermined frequency band units. For example, the third transformation unit 1130 may perform domain transformation by applying a QMF.

The bandwidth extension encoding unit 1135 may encode the high-frequency signal transformed by the third transformation unit 1130, by using the low-frequency signal. For the encoding, information to decode the high-frequency signal by using the low-frequency signal, may be encoded.

The multiplexing unit 1140 may multiplex into a bitstream the frequency component(s) encoded by the frequency component encoding unit 1105, information representing the location(s) of the frequency component(s), the envelope of the low-frequency signal encoded by the envelope encoding unit 1125, the low-frequency signal encoded by the bandwidth extension encoding unit 1135, and the information to decode the high-frequency signal, and then may output the bitstream via an output terminal OUT.

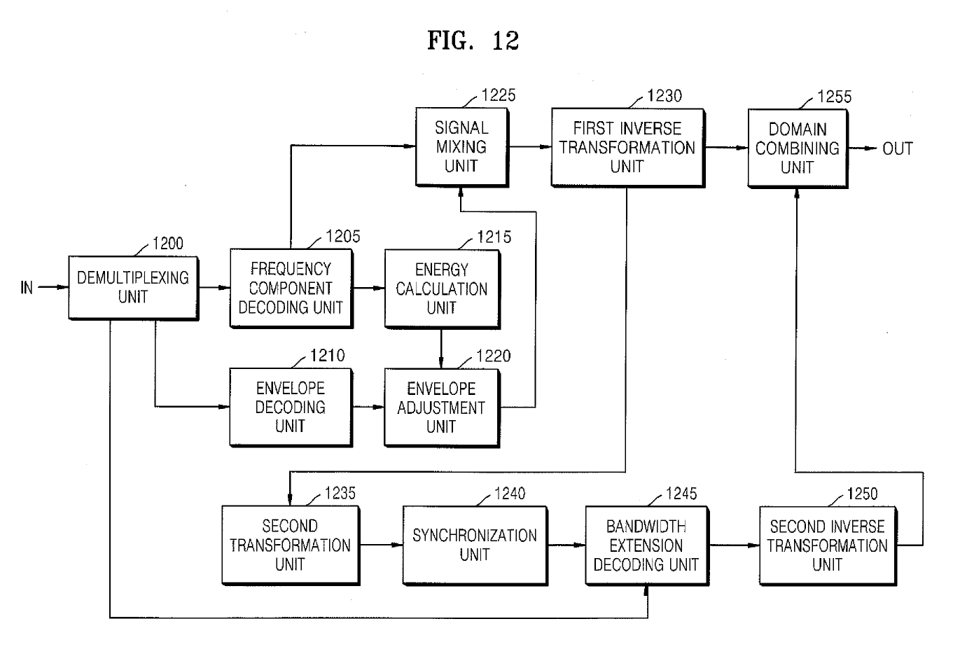

FIG. 12 is a block diagram of an apparatus to decode an audio signal according to another embodiment of the present general inventive concept. The decoding apparatus may include a demultiplexing unit 1200, a frequency component decoding unit 1205, an envelope decoding unit 1210, an energy calculation unit 1215, an envelope adjustment unit 1220, a signal mixing unit 1225, a first inverse transformation unit 1230, a second transformation unit 1235, a synchronization unit 1240, a bandwidth extension decoding unit 1245, a second inverse transformation unit 1250, and a domain combining unit 1255.

The demultiplexing unit 1200 may receive a bitstream from an encoding terminal via an input terminal IN and then may demultiplex the bitstream. For example, the demultiplexing unit 1200 may demultiplex the bitstream into one or more frequency components, information representing location(s) of the frequency component(s), an envelope of a low-frequency signal that may be encoded by an encoding apparatus (not shown), and information being generated from the low-frequency signal in order to decode a high-frequency signal. Here, the low-frequency signal has a frequency band less than a predetermined first frequency and the high-frequency signal has a frequency band greater than a predetermined second frequency. In one aspect of the present general inventive concept, the first frequency and the second frequency may be the same, but it is understood the first frequency and the second frequency may also be different from each other.

The frequency component decoding unit 1205 may decode a frequency component (or components) that was determined to be an important frequency component from the low-frequency signal according to predetermined criteria and thus encoded by an encoding apparatus (not shown).

The envelope decoding unit 1210 may decode the envelope of the low-frequency signal encoded by the encoding apparatus.

The energy calculation unit 1215 may calculate the energy value(s) of the frequency component(s) decoded by the frequency component decoding unit 1205.

The envelope adjustment unit 1220 may adjust the envelope of the low-frequency signal decoded by the envelope decoding unit 1210, at a band (or bands) containing the frequency component(s) decoded by the frequency component decoding unit 1205. Here, the envelope adjustment unit 1220 may adjust the envelope decoded by the envelope decoding unit 1210 so that the energy value of the decoded envelope at each band can be equal to the value obtained by subtracting the energy value of the contained frequency component(s) from the energy value of the decoded envelope at the band(s) containing the frequency component(s) decoded by the frequency component decoding unit 1205.

However, the envelope adjustment unit 1220 may not adjust the envelope decoded by the envelope decoding unit 1210, at the other bands that do not contain the frequency component(s) decoded by the frequency component decoding unit 1205.

The signal mixing unit 1225 may output the result of mixing the frequency component(s) decoded by the frequency component decoding unit 1205 and the envelope adjusted by the envelope adjustment unit 1220, at the band(s) containing the frequency component(s) decoded by the frequency component decoding unit 1205 from among frequency bands less than a predetermined frequency, and may output the signal decoded by the envelope decoding unit 1210 at the other bands that do not contain the decoded frequency component(s) from among the frequency bands less than the predetermined frequency. Thus, the signal mixing unit 1225 can restore the low-frequency signal.

The first inverse transformation unit 1230 may transform the low-frequency signal restored by the signal mixing unit 1225 from the frequency domain to the time domain according to a predetermined first inverse transformation method (which may be an inverse operation of the transformation performed by the first transformation unit 1103 of FIG. 11). An example of the first inverse transformation method is IMDCT.

The second transformation unit 1235 may perform domain transformation on the low-frequency signal, which was inversely transformed by the first inverse transformation unit 1230, by using an analysis filterbank so that this signal can be represented in the time domain in predetermined frequency band units. For example, the second transformation unit 1235 may perform domain transformation by applying a QMF.

If frames applied to the frequency component decoding unit 1205 are not the same as those applied to the bandwidth extension decoding unit 1245, the synchronization unit 1240 synchronizes the frames applied to the frequency component decoding unit 1205 with those applied to the bandwidth extension decoding unit 1245. The synchronization unit 1240 may process all or some of the frames applied to the bandwidth extension decoding unit 1245, based on the frames applied to the frequency component decoding unit 1205.

The bandwidth extension decoding unit 1245 may decode a high-frequency signal second by using the low-frequency signal transformed by the transformation unit 1235. For the decoding, information to decode the high-frequency signal by using the low-frequency signal being demultiplexed by the demultiplexing unit 1200 may be used.

The second inverse transformation unit 1250 may perform inverse transformation on the domain of the high-frequency signal, which was decoded by the bandwidth extension decoding unit 1245, by using a synthesis filterbank, where the inverse transformation may be a reverse operation of the transformation performed by the second transformation unit 1235.

The domain combining unit 1255 may mix the low-frequency signal being inversely transformed by the first inverse transformation unit 1230 and the high-frequency signal being inversely transformed by the second inverse transformation unit 1250 and then may output the result of mixing via an output terminal OUT.

FIG. 13 is a block diagram illustrates in detail the signal adjustment unit 220 (or 620, 825 or 1020) included in a decoding apparatus, according to another embodiment of the present general inventive concept. The signal adjustment unit 220 (or 620, 825 or 1020) may include a first energy calculation unit 1300, a second energy calculation unit 1310, a gain calculation unit 1320, and a gain applying unit 1330. The signal adjustment unit 220 (or 620, 825 or 1020) will now be described with reference to FIGS. 2, 6, 8, 10 and 13.

The first energy calculation unit 1300 may receive one or more signals, which were generated by the signal generation unit 215 (or 615, 820 or 1015) at one or more bands containing one or more frequency components, via a first input terminal IN1 and then may calculate the energy value of the signal(s) at one or more bands.

The second energy calculation unit 1310 may receive a frequency component (or components) decoded by the frequency component decoding unit 205, 605, 805 or 1005 via a second input terminal IN2 and then may calculate the energy value(s) of the frequency component(s).

The gain calculation unit 1320 may receive the energy value(s) of the band(s) containing the frequency component(s) from the energy value decoding unit 210, 610, 810 or 1010 via a third input terminal IN3, and then may calculate a gain of the received energy value(s) that can satisfy a relationship whereby each of the energy value(s) calculated by the first energy calculation unit 1300 may be equal to the value obtained by subtracting one of the energy value(s) calculated by the second energy calculation unit 1310 from one of energy value(s) received from the energy value decoding unit 210, 610, 810 or 1010. For example, the gain calculation unit 1320 may calculate the gain as follows:

$$g = \sqrt{\frac{{E}_{target} - {E}_{core}}{{E}_{seed}}} , \qquad ( 1 )$$

wherein E_{target} denotes each of the energy values received from the energy value decoding unit 210, 610, 810 or 1010, E_{core} denotes each of the energy values calculated by the second energy calculation unit 1310, and E_{seed} denotes each of the energy values calculated by the first energy calculation unit 1300.

If the gain is calculated in consideration of a signal tonality, the gain calculation unit 1320 may receive the energy value(s) of the band(s) containing the frequency component(s) from the energy value decoding unit 210, 610, 810 or 1010 via the third input terminal IN3, may receive the tonality (or tonalities) of a signal or signals at the band(s) containing the frequency component(s) via a fourth input terminal IN4, and then may calculate a gain or gains by using the received energy values, the tonality (or tonalities), and the energy value(s) calculated by the second energy calculation unit 1310.

The gain applying unit 1330 may receive a signal or signals, which were generated by the signal generation unit 215, 615, 820 or 1015 at the band(s) containing the frequency component(s), via the first input terminal IN1 and then applies the calculated gain(s) to the signal(s).

FIG. 14 is a circuit diagram illustrating application of a gain when the signal generation unit 215, 615, 820 or 1015 illustrated in FIG. 2, 6, 8 or 10 generates a signal from only a single signal, according to an embodiment of the present general inventive concept.

The gain applying unit 1330 may receive via a first input terminal IN1 a signal or signals generated by the signal generation unit 215, 615, 820 or 1015 at a band or bands containing one or more frequency components and then multiplies the value(s) of the signal(s) by a gain calculated by the gain calculation unit 1320.

A first signal mixing unit 1400 may receive a frequency component (or component) decoded by the frequency component decoding unit 205, 605, 805 or 1005 via a second input terminal IN 2 and then may mix the frequency component(s) and the signal(s) whose value(s) were multiplied by the gain by the gain applying unit 1330.

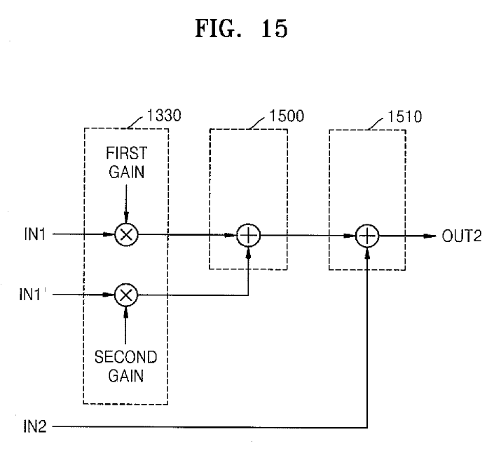

FIG. 15 is a circuit diagram illustrating application of a gain when the signal generation unit 215, 615, 820 or 1015 illustrated in FIG. 2, 6, 8 or 10 generates a signal from a plurality of signals, according to an embodiment of the present general inventive concept.

First, a gain applying unit 1330 may receive a signal being arbitrarily generated by the signal generation unit 215, 615, 820 or 1015 via a first input terminal IN1 and then multiplies the value of the signal by a first gain calculated by a gain calculation unit 1320.

Also, the gain applying unit 1330 may receive a signal via an input terminal IN 1′ from among a signal obtained by duplicating the signal generated by the signal generation unit 215, 615, 820 or 1015 at a predetermined band, a signal obtained by duplicating a low-frequency signal, a signal generated using a signal at a predetermined band, and a signal generated from the low-frequency signal, and then multiplies the value of the received signal by a second gain calculated by the gain calculation unit 1320.

A second mixing unit 1500 may mix the signal whose value was multiplied by the first gain by the gain applying unit 1330 and the signal whose value was multiplied by the second gain by the gain applying unit 1330.

A third signal mixing unit 1510 may receive one or more frequency components decoded by the frequency component decoding unit 205, 605, 805 or 1005 via a second input terminal IN2 and then may mix the frequency component(s) and the mixed signal received from the second mixing unit 1500.

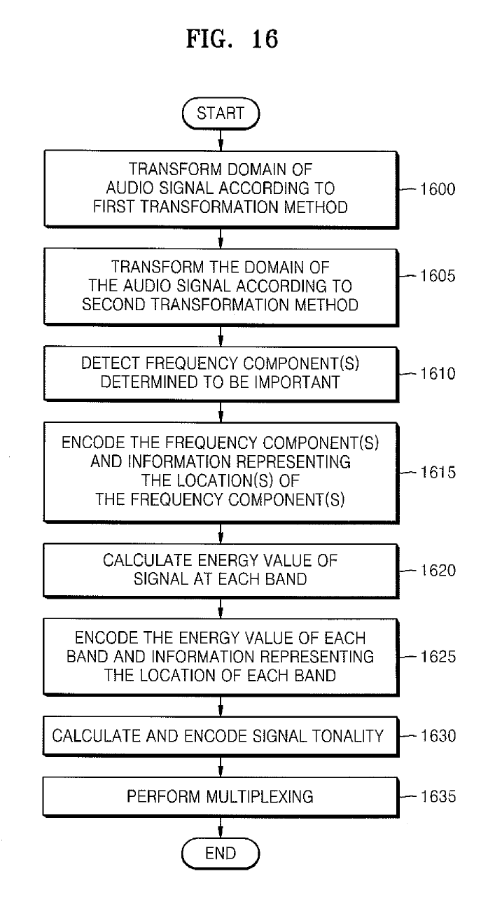

FIG. 16 is a flowchart illustrating a method of encoding an audio signal according to an embodiment of the present general inventive concept.

First, a received audio signal may be transformed from the time domain to the frequency domain according to a predetermined first transformation method (operation 1600). Here, examples of the audio signal are a speech signal and a music signal.

Next, the audio signal may be transformed from the time domain to the frequency domain according to a predetermined second transformation method that may be different to the first transformation method, in order to apply a psychoacoustic model (operation 1605).

The signal transformed in operation 1600 may be used to encode the audio signal, and the signal transformed in operation 1605 may be used to detect important frequency components by applying a psychoacoustic model to the audio signal. Here, the psychoacoustic model may be a mathematical model regarding a masking reaction of the human auditory system.

For example, in operation 1600, the audio signal may be represented with real numbers by transforming it into the frequency domain by using MDCT as the first transformation method, and in operation 1605, the audio signal may be represented with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Accordingly, since the phase information of the audio signal can be further represented, DFT may be performed on the signal corresponding to the time domain and then MDCT coefficients may be quantized, thereby preventing a mismatch from occurring.

Next, one or more frequency components determined to be an important frequency component or components may be detected from the signal transformed in operation 1600 according to predetermined criteria, by using the signal transformed in operation 1605 (operation 1610). Various methods can be used to detect an important frequency component(s) in operation 1610. First, the SMR of a signal may be calculated, and then, the signal may be determined to be an important frequency component if the value of the signal is greater than the reciprocal of a masking value. Second, whether a signal is an important frequency component may be determined by extracting a spectrum peak in consideration of a predetermined weight. Third, the SNR of each of sub bands may be calculated and then a frequency component(s) having a peak value equal to or greater than a predetermined value may be selected as an important frequency component(s) from among sub bands having a small SNR. The above three methods may be individually performed, or one or a combination of at least two of the three methods may be performed. The above three methods are just examples and thus the present general inventive concept is not limited thereto.

Then, the frequency component(s) detected in operation 1610 and information representing location(s) of the frequency component(s) may be encoded (operation 1615).

Next, the energy values of a signal or signals at the bands of the signal transformed in operation 1600 may be calculated (operation 1620). Here, the band may be one sub band or one scale factor band in the case of a QMF.

Next, the energy values of the bands calculated in operation 1620 and information representing locations of the bands may be encoded (operation 1625).

Next, a tonality of the signal(s) at a band or bands containing the frequency component(s) detected in operation 1610 may be calculated and encoded (operation 1630). However, operation 1630 is not indispensable to the present general inventive concept but may be needed if a decoding apparatus (not shown) generates a signal not from a single signal but from a plurality of signals at the band(s) containing the frequency component(s). For example, operation 1610 may be performed when the decoding apparatus generates a signal or signals at the band(s) containing the frequency component(s) by using both a signal being arbitrarily generated and a patched signal.

Next, the frequency component(s) and the information representing the location(s) of the frequency component(s) that were encoded in operation 1615, and the energy values of the bands and the information representing the locations of the bands that were encoded in operation 1625 may be multiplexed together into a bitstream (operation 1635). Alternatively, in operation 1635, the tonality (or tonalities) encoded in operation 1630 may also be multiplexed into the bitstream.

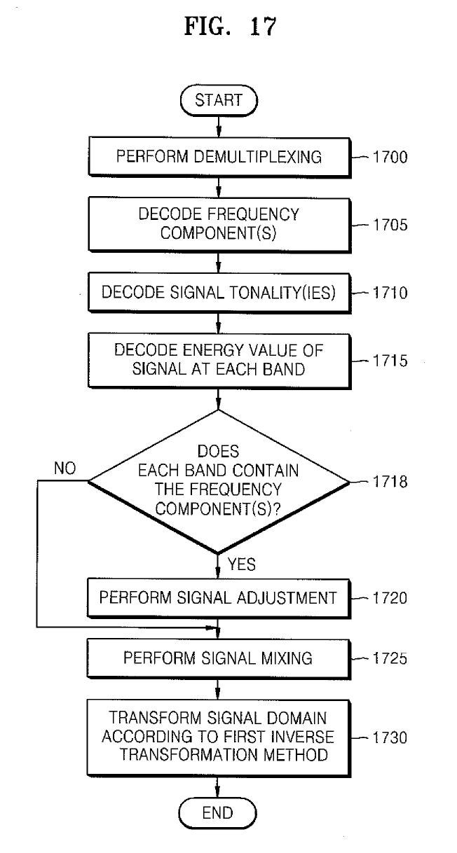

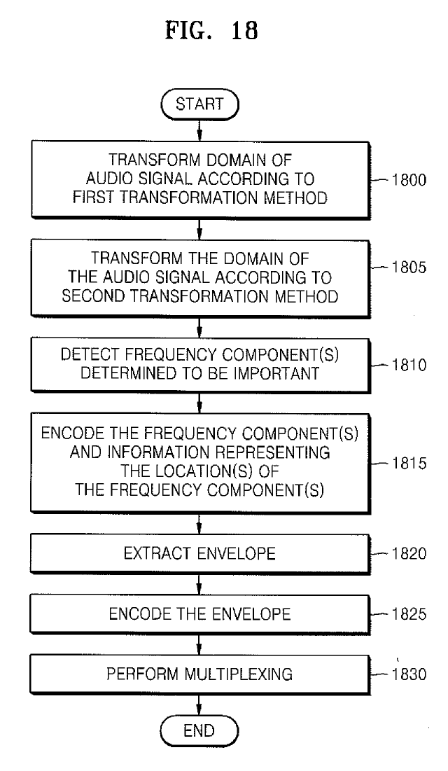

FIG. 17 is a flowchart illustrating a method of encoding an audio signal according to an embodiment of the present general inventive concept.

First, a bitstream may be received from an encoding terminal and then may be demultiplexed (operation 1700). For example, in operation 1700, the bitstream may be demultiplexed into one or more frequency components, information representing location(s) of the frequency component(s), the energy value of each band, information representing location(s) of one or more bands whose energy values may be encoded by an encoding apparatus (not shown), and signal tonality(ies).

Next, a frequency component (or components) that were determined to be important according to predetermined criteria and then encoded by the encoding apparatus, may be decoded (operation 1705).

Next, the energy value of a signal at each band may be decoded (operation 1710).

Next, a tonality (or tonalities) of a signal (or signals) at a band (or bands) containing the frequency component(s) decoded in operation 1705 may be decoded (operation 1713). However, operation 1713 is not indispensable to the present general inventive concept but may be needed if a signal is generated from a plurality of signals, rather than from a single signal, in operation 1715. For example, it may be necessary to perform operation 1713 when a signal or signals may be generated at the band(s) containing the frequency component(s), which was decoded in operation 1705, in operation 1715 by using both an arbitrarily generated noise signal and a patched signal. If operation 1713 is included, the tonality(ies) decoded in operation 1713 may also be considered when adjusting a signal or signals, which may be generated in operation 1715, in operation 1720.

Next, a signal having the energy value at each band that was decoded in operation 1710 may be generated at each band (operation 1715).

In operation 1715, various methods can be used to generate a signal at each band. First, a noise signal may be generated arbitrarily. Second, if a signal at a predetermined band is a high-frequency signal corresponding to a frequency band greater than a predetermined frequency and a low-frequency signal corresponding to a frequency band less than the predetermined frequency has already been decoded and thus is available, then a signal may be generated by duplicating the low-frequency signal. For example, a signal may be generated by patching or folding the low-frequency signal.

Then, it may be determined whether each of the band(s) contains the frequency component(s) decoded in operation 1705 (operation 1718).

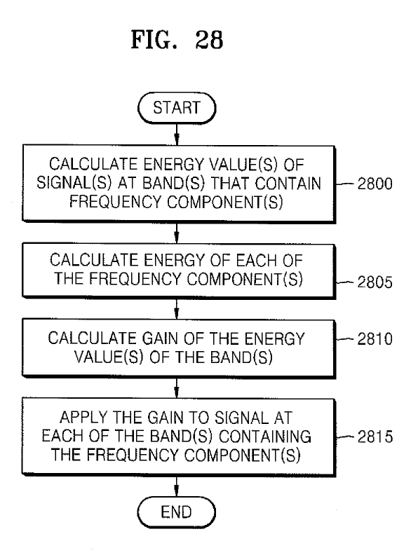

If it is determined in operation 1718 that each of the bands contains the decoded frequency component(s), a signal or signals at the band(s) containing the frequency component(s) from among the signal(s) generated in operation 1715 may be adjusted (operation 1720). Specifically, in operation 1720, the signal(s) generated in operation 1715 may be adjusted so that the energy values of the generated signal(s) can be adjusted, based on the energy value at each band decoded in operation 1710 and in consideration of the energy value(s) of the frequency component(s) decoded in operation 1705. Operation 1720 will be described later in greater detail with reference to FIG. 28.

However, if it is determined in operation 1718 that each of the bands does not contain the decoded frequency component(s), a signal or signals at the other bands that do not contain the decoded frequency component(s) from among the signal(s) generated in operation 1715 may not be adjusted.

Next, the result of mixing the frequency component(s) decoded in operation 1705 and the signal(s) adjusted in operation 1720 may be output at the band(s) containing the decoded frequency component(s), and the signal(s) generated in operation 1715 may be output at the other bands that do not contain the decoded frequency component(s) (operation 1725).

Then, the signals output in operation 1725 may be transformed from the frequency domain to the time domain according to a predetermined first inverse transformation method, in the reverse manner that transformation is performed in operation 1600 illustrated in FIG. 16 (operation 1730). An example of the first inverse transformation method is IMDCT.

FIG. 18 is a flowchart illustrating a method of encoding an audio signal according to another embodiment of the present general inventive concept.

First, a received audio signal may be transformed from the time domain to the frequency domain according to a predetermined first transformation method (operation 1800). Here, examples of the audio signal are a speech signal and a music signal.

Next, the audio signal may be transformed from the time domain to the frequency domain according to a predetermined second transformation method that may be different to the first transformation method, in order to apply a psychoacoustic model (operation 1805).

The signal transformed in operation 1800 may be used to encode the audio signal, and the signal transformed in operation 1805 may be used to detect important frequency components by applying a psychoacoustic model to the audio signal. Here, the psychoacoustic model may be a mathematical model regarding a masking reaction of the human auditory system.

For example, in operation 1800, the audio signal may be represented with real numbers by transforming it into the frequency domain by using MDCT as the first transformation method, and in operation 1805, the audio signal may be represented with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Accordingly, since the phase information of the audio signal can be further represented, DFT may be performed on the signal corresponding to the time domain and then MDCT coefficients may be quantized, thereby preventing a mismatch from occurring.

Next, one or more frequency components determined to be important may be detected from the signal transformed in operation 1800 according to predetermined criteria, by using the signal transformed in operation 1805 (operation 1810). Various methods can be used to detect an important frequency component(s) in operation 1810. First, the SMR of a signal may be calculated, and then the signal may be determined to be an important frequency component if the value of the signal is greater than the reciprocal of a masking value. Second, whether a signal is an important frequency component may be determined by extracting a spectrum peak in consideration of a predetermined weight. Third, the SNR of each of sub bands may be calculated and then each frequency component having a peak value equal to or greater than a predetermined value may be selected as an important frequency component from among sub bands having a small SNR. The above three methods may be individually performed, or one or a combination of at least two of the three methods may be performed. The above three methods are just examples and thus the present general inventive concept is not limited thereto.

Then, the frequency component(s) detected in operation 1810 and information representing location(s) of the frequency component(s) may be encoded (operation 1815).

Next, an envelope of the signal transformed in operation 1800 may be extracted (operation 1820).

Next, the envelope extracted in operation 1820 may be encoded (operation 1825).

Thereafter, the frequency component(s) and the information representing the location(s) of the frequency component(s) that may be encoded in operation 1815, and the envelope encoded in operation 1825 may be multiplexed into a bitstream (operation 1830).

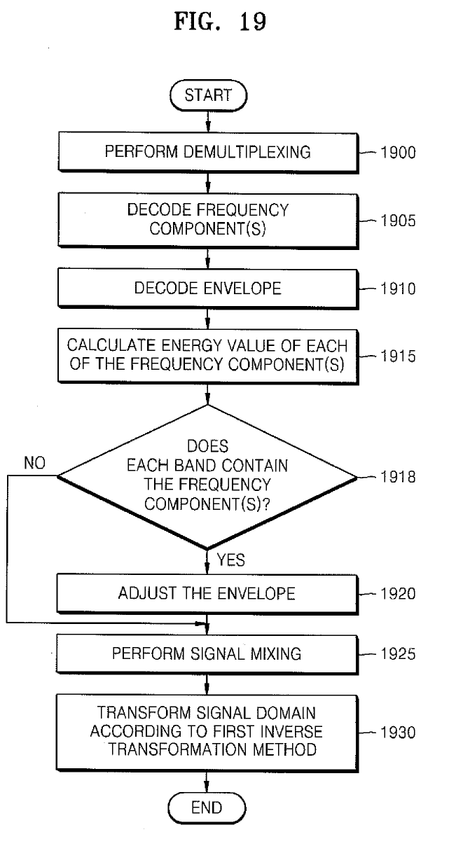

FIG. 19 is a flowchart illustrating a method of decoding an audio signal according to another embodiment of the present general inventive concept.

First, a bitstream may be received from an encoding terminal and then may be demultiplexed (operation 1900). For example, the bitstream may be demultiplexed into a frequency component (or components), information representing location(s) of the frequency component(s), and an envelope encoded in an encoding apparatus (not shown).

Next, a frequency component (or components) that was determined to be important according to predetermined criteria and then encoded by the encoding apparatus, may be decoded (operation 1905).

Next, the envelope encoded by the encoding apparatus may be decoded (operation 1910).

Next, the energy value(s) of the frequency component(s) decoded in operation 1905 may be decoded (operation 1915).

Next, it may be determined whether each band contains the decoded frequency component(s) (operation 1918).

If it is determined in operation 1918 that each band contains the decoded frequency component(s), the envelope of a signal (or signals) at a band (or bands) containing the decoded frequency component(s) may be adjusted, from among envelopes decoded in operation 1910 (operation 1920). In operation 1920, the decoded envelope at each band in operation 1910 may be controlled so that the energy value of the envelope is equal to the value obtained by subtracting the energy value of a frequency component(s) contained in each band from the energy value of the envelope at each band containing the decoded frequency component(s). If it is determined in operation 1918 that each band does not contain the frequency component(s), the envelope of a signal (or signals) at the other bands that do not contain the decoded frequency component(s) may not be adjusted, from among envelops decoded in operation 1915.

Then, the result of mixing the frequency component(s) decoded in operation 1905 and the envelope(s) adjusted in operation 1920 may be output at the band(s) containing the decoded frequency component(s), and the signal(s) decoded in operation 1910 may be output at the other bands that do not contain the decoded frequency component(s) (operation 1925).

Thereafter, the signal(s) output in operation 1925 may be transformed from the frequency domain to the time domain according to a predetermined first inverse transformation method, in the reverse manner that the transformation is performed in operation 1800 of FIG. 18 (operation 1930). An example of the first inverse transformation method is IMDCT.

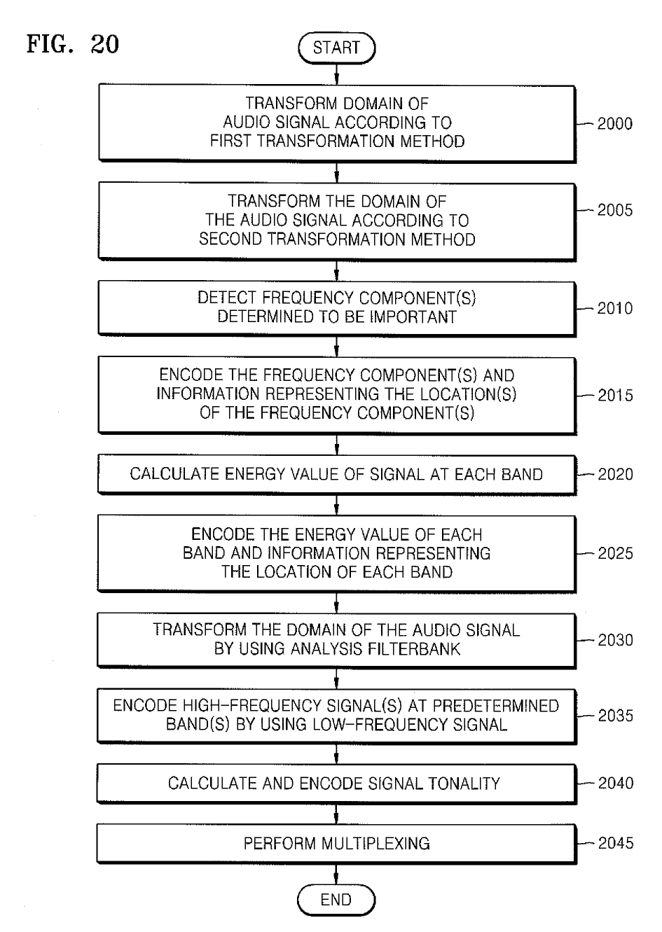

FIG. 20 is a flowchart illustrating a method of encoding an audio signal according to another embodiment of the present general inventive concept.

First, a received audio signal (or signals) may be transformed from the time domain to the frequency domain according to a predetermined first transformation method (operation 2000). Here, examples of the audio signal are a speech signal and a music signal.

Next, the audio signal(s) may be transformed from the time domain to the frequency domain according to a predetermined second transformation method that may be different to the first transformation method, in order to apply a psychoacoustic model (operation 2005).

The signal transformed in operation 2000 may be used to encode the audio signal, and the signal transformed in operation 2005 may be used to detect important frequency components by applying a psychoacoustic model to the audio signal. Here, the psychoacoustic model may be a mathematical model regarding a masking reaction of the human auditory system.

For example, in operation 2000, the audio signal may be represented with real numbers by transforming it into the frequency domain by using MDCT as the first transformation method, and in operation 2005, the audio signal may be represented with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Accordingly, since the phase information of the audio signal can be further represented, DFT may be performed on the signal corresponding to the time domain and then MDCT coefficients may be quantized, thereby preventing a mismatch from occurring.

Next, a frequency component or components determined to be important may be detected from the signal transformed in operation 2000 according to predetermined criteria, by using the signal transformed in operation 2005 (operation 2010). Various methods can be used to detect an important frequency component in operation 2010. First, the SMR of a signal may be calculated, and then, the signal may be determined to be an important frequency component if the value of the signal is greater than the reciprocal of a masking value. Second, whether a signal is an important frequency component may be determined by extracting a spectrum peak in consideration of a predetermined weight. Third, the SNR of each of sub bands may be calculated and then a frequency component having a peak value equal to or greater than a predetermined value may be selected as an important frequency component, from among sub bands having a small SNR. The above three methods may be individually performed, or one or a combination of at least two of the three methods may be performed. The above three methods are just examples and thus the present general inventive concept is not limited thereto.

Then, the frequency component(s) detected in operation 2010 and information representing location(s) of the frequency component(s) may be encoded (operation 2015).

Next, the energy value(s) of a signal or signals at one or more bands containing the frequency component(s) encoded in operation 2015, or a frequency band or bands less than a predetermined first frequency, may be calculated (operation 2020). Here, the band(s) may be one sub band or one scale factor band in the case of a QMF.

Next, the energy value of the band(s) that may be calculated in operation 2020 and information representing location(s) of the band(s) may be encoded (operation 2025).

Then, domain transformation may be performed on the audio signal so that the audio signal can be represented in the time domain in predetermined frequency band units, by using an analysis filterbank (operation 2030). For example, domain transformation may be performed by applying the QMF in operation 2030.

Next, the signal transformed in operation 2030, which corresponds to a frequency band greater than a predetermined frequency from among bands that do not contain the frequency component(s) detected in operation 2010, may be encoded using a low-frequency signal corresponding to a frequency band less than the predetermined frequency (operation 2035). For the encoding, information to decode a signal or signals at a frequency band or bands greater than the predetermined frequency by using the low-frequency signal may be encoded.

Next, a tonality (or tonalities) of a signal or signals from among the signal(s), which was transformed in operation 2000, at the band(s) containing the frequency component(s) detected in operation 2010 may be calculated and then encoded (operation 2040). However, operation 2040 is not indispensable to the present general inventive concept but may be needed if a decoding apparatus (not shown) generates a signal not from a single signal but from a plurality of signals at the band(s) containing the frequency component(s). For example, operation 2040 may be performed when the decoding apparatus generates a signal or signals at the band(s) containing the frequency component(s) by using both a signal being arbitrarily generated and a patched signal.

Thereafter, the decoded frequency component(s) and the information representing location(s) of the decoded frequency component(s) that were encoded in operation 2015, the energy value(s) of the band(s) and the information representing locations of the bands that were encoded in operation 2025, and the signal encoded in operation 2035 may be multiplexed together into a bitstream, and then, the bitstream may be output (operation 2045). Alternatively, in operation 2045, the tonality(ies) encoded in operation 2040 may also be multiplexed into the bitstream.

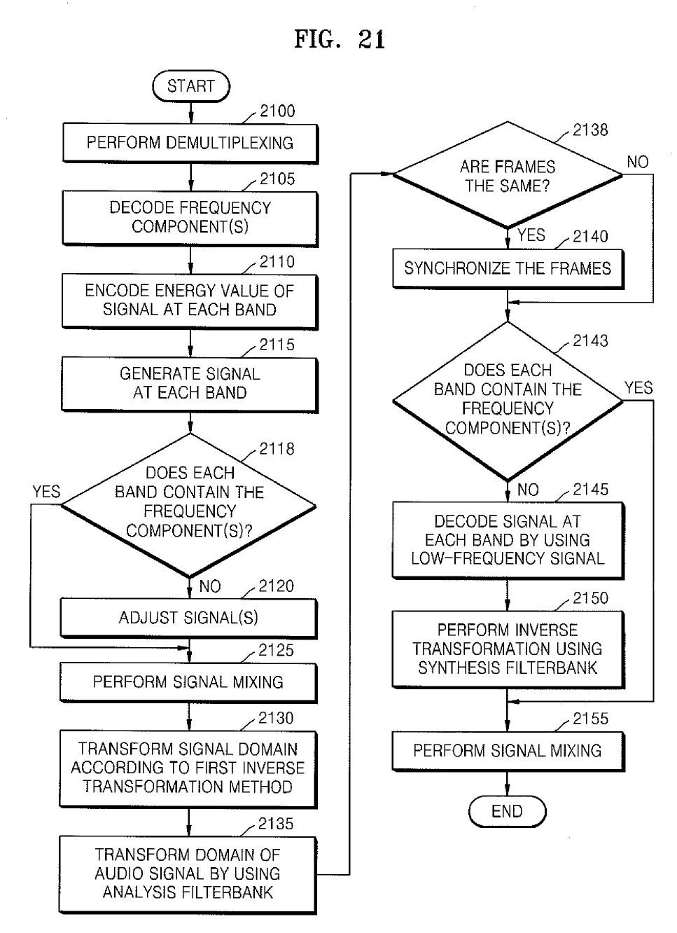

FIG. 21 is a flowchart illustrating a method of decoding an audio signal according to another embodiment of the present general inventive concept.

First, a bitstream may be received from an encoding terminal and then may be demultiplexed (operation 2100). For example, in operation 2100, the bitstream may be demultiplexed into one or more frequency components; information representing location(s) of the frequency component(s); the energy value of each band; information representing location(s) of one or more bands whose energy values may be encoded by an encoding apparatus (not shown); information to decode a signal (or signals) at a band (or bands), which does not contain one or more frequency components from among one or more frequency bands greater than a predetermined frequency, by using a signal corresponding to a signal corresponding to a frequency band less than the predetermined frequency; and signal tonality(ies).

Next, a frequency component(s) that was determined to be important according to predetermined criteria and then encoded by the encoding apparatus, may be decoded (operation 2105).

Next, the energy value of a signal either at the band(s) containing the frequency component(s) decoded in operation 2105 or a frequency band(s) less than a predetermined frequency, may be decoded (operation 2110).

Next, a tonality(ies) of the signal(s) at the band(s) containing the decoded frequency component(s) may be decoded (operation 2113). However, operation 2113 is not indispensable to the present general inventive concept but may be needed if a signal is generated from a plurality of signals, rather than from a single signal, in operation 2115 (which will be described later). For example, it may be necessary to perform operation 2113 when a signal or signals are generated at the band(s) containing the decoded frequency component(s) in operation 2115 by using both an arbitrarily generated noise signal and a patched signal. If operation 2113 is included, the tonality(ies) decoded in operation 2113 may also be considered when adjusting a signal or signals, which may be generated in operation 2115, in operation 2120 which will be described later.

Next, a signal having the energy value(s) at the band(s) containing the decoded frequency component(s) or at the frequency band(s) less than the predetermined frequency, the energy value being decoded in operation 2110m may be generated at each band (operation 2115).

In operation 2115, various methods can be used to generate a signal at each band. First, a noise signal may be generated arbitrarily. Second, if a signal at a predetermined band is a high-frequency signal corresponding to a frequency band greater than a predetermined frequency and a low-frequency signal corresponding to a frequency band less than the predetermined frequency has already been decoded and thus is available, then a signal may be generated by duplicating the low-frequency signal. For example, a signal may be generated by patching or folding the low-frequency signal.

Then, it may be determined whether each of the band(s) contains the frequency component(s) decoded in operation 2105 (operation 2118).

If it is determined in operation 1718 that each of the bands contains the decoded frequency component(s), a signal or signals at the band(s) containing the frequency component(s) may be adjusted, from among the signal(s) generated in operation 2115 (operation 2120). Specifically, in operation 2120, the signal(s) generated in operation 2115 may be adjusted so that the energy values of the generated signal(s) can be adjusted, based on the energy value decoded in operation 2110 and in consideration of the energy value(s) of the frequency component(s) decoded in operation 2105. Operation 2120 will be described later in greater detail with reference to FIG. 28.

However, if it is determined in operation 2118 that each of the bands does not contain the decoded frequency component(s), a signal or signals at the other bands that do not contain the decoded frequency component(s) from among the signal(s) generated in operation 2115 may not be adjusted.

Next, the result of mixing the frequency component(s) decoded in operation 2105 and the signal(s) adjusted in operation 2120 may be output at the band(s) containing the decoded frequency component(s), and the signal(s) generated in operation 2115 may be output at the other bands that do not contain the decoded frequency component(s) (operation 2125).

Then, the signals output in operation 2125 may be transformed from the frequency domain to the time domain according to a predetermined first inverse transformation method, in the reverse manner that the transformation is performed in operation 2000 illustrated in FIG. 20 (operation 2130). An example of the first inverse transformation method is IMDCT.

Next, domain transformation may be performed on the signals being transformed in operation 2130 so that the signals can be represented in the time domain in predetermined frequency band units, by using an analysis filterbank (operation 2135). For example, domain transformation may be performed by applying a QMF.

Next, it may be determined whether frames applied in operation 2105 are the same as those applied in operation 2145 (operation 2138).

If it is determined in operation 2138 that the frames are not the same, the frames applied in operation 2105 may be synchronized with the frames applied in operation 2145 (operation 2140). In operation 2140, all or some of the frames applied in operation 2145 may be processed based on the frames applied in operation 2105.

Next, it may be determined whether the frequency band(s) greater than the predetermined frequency contain(s) the decoded frequency component(s) (operation 2143).

If it is determined in operation 2143 that the band(s) contain(s) the decoded frequency component(s), a signal(s) at a band(s) that do not contain the decoded frequency component(s) from among the frequency band(s) greater than the predetermined frequency, may be decoded using a signal corresponding to the frequency band less than the predetermined frequency from among the signal(s) transformed in operation 2135 (operation 2145). For the decoding, the information to decode a signal corresponding to a frequency band greater than the predetermined frequency by using the signal corresponding to the frequency band less than the predetermined frequency may be used, the information being demultiplexed in operation 2100.

Then, the domain of the signal decoded in operation 2145 may be inversely transformed using a synthesis filterbank, in the reverse manner that the transformation was performed in operation 2135 (operation 2150).

Thereafter, the signals being respectively inversely transformed in operations 2130 and 2150 may be mixed together (operation 2155). The signal(s) being inversely transformed in operation 2130 may include the signal(s) at the band(s) containing the decoded frequency component(s), and the signal(s) at the frequency band(s) less than the predetermined frequency from among the other band(s) that do not contain the decoded frequency component(s). Also, the signal(s) being inversely transformed in operation 2150 may include the signal(s) at the frequency band(s) greater than the predetermined frequency from among the other band(s) that do not contain the decoded frequency component(s). Accordingly, in operation 2155, the audio signal can be restored by mixing audio signals at all the frequency bands.

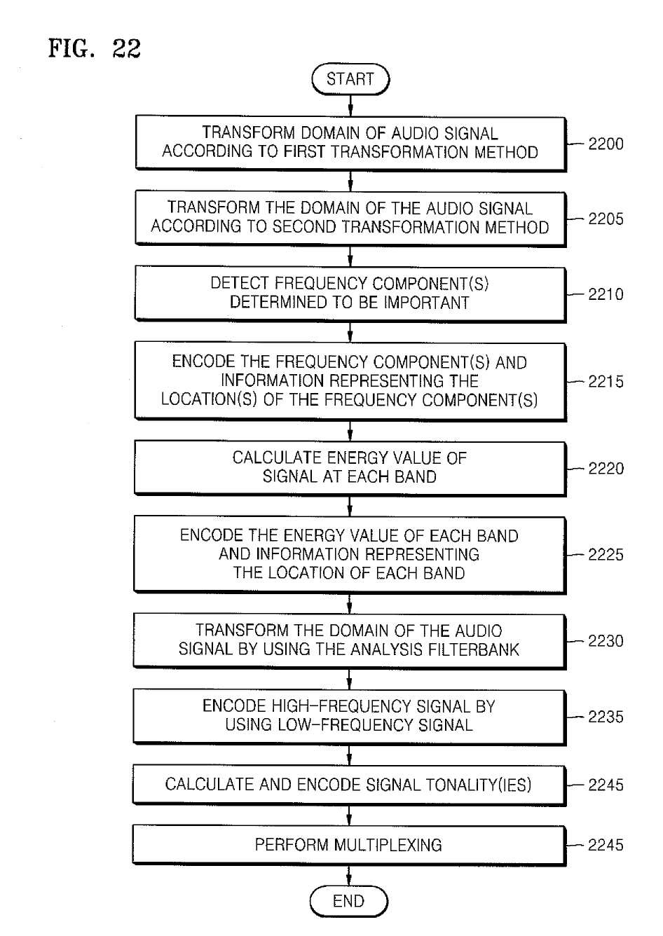

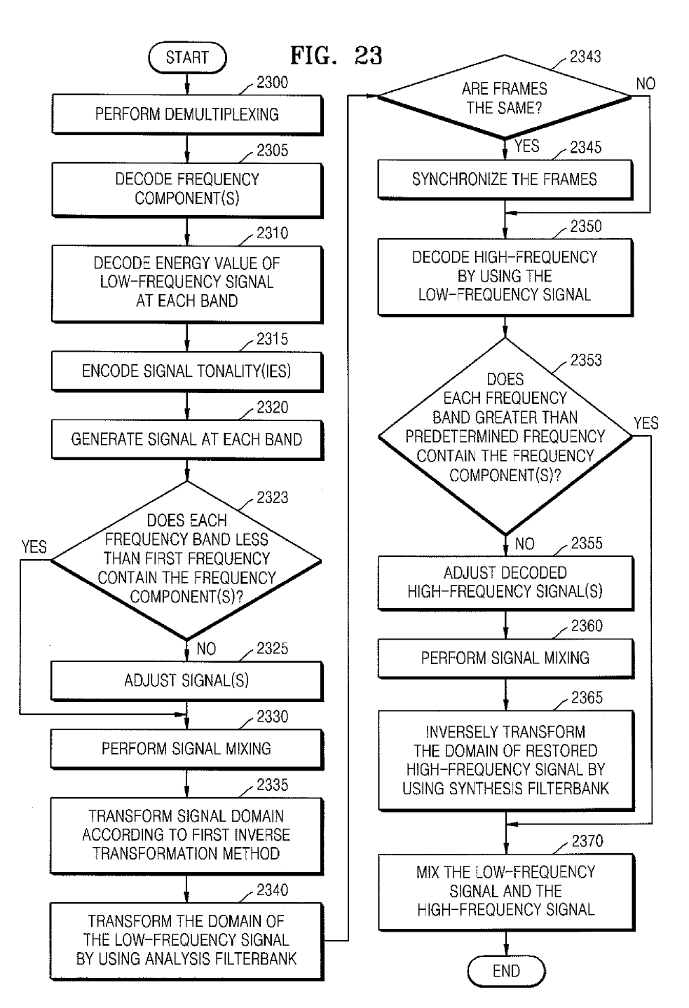

FIG. 22 is a flowchart illustrating a method of encoding an audio signal according to another embodiment of the present general inventive concept.

First, a received audio signal may be transformed from the time domain to the frequency domain according to a predetermined first transformation method (operation 2200). Here, examples of the audio signal are a speech signal and a music signal.

Next, the audio signal may be transformed from the time domain to the frequency domain according to a predetermined second transformation method that may be different to the first transformation method, in order to apply a psychoacoustic model (operation 2205).

The signal transformed in operation 2200 may be used to encode the audio signal, and the signal transformed in operation 2205 may be used to detect important frequency components by applying a psychoacoustic model to the audio signal. Here, the psychoacoustic model may be a mathematical model regarding a masking reaction of the human auditory system.

For example, in operation 2200, the audio signal may be represented with real numbers by transforming it into the frequency domain by using MDCT as the first transformation method, and in operation 2205, the audio signal may be represented with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Accordingly, since the phase information of the audio signal can be further represented, DFT may be performed on the signal corresponding to the time domain and then MDCT coefficients may be quantized, thereby preventing a mismatch from occurring.

Next, one or more frequency components determined to be important may be detected from the signal transformed in operation 2200 according to predetermined criteria, by using the signal transformed in operation 2205 (operation 2210). Various methods can be used to detect an important frequency component in operation 2210. First, the SMR of a signal may be calculated, and then, the signal may be determined to be an important frequency component if the value of the signal is greater than the reciprocal of a masking value. Second, whether a signal is an important frequency component may be determined by extracting a spectrum peak in consideration of a predetermined weight. Third, the SNR of each of sub bands may be calculated and then a frequency component having a peak value equal to or greater than a predetermined value may be selected as an important frequency component from among sub bands having a small SNR. The above three methods may be individually performed, or one or a combination of at least two of the three methods may be performed. The above three methods are just examples and thus the present general inventive concept is not limited thereto.

Then, the frequency component(s) detected in operation 2210 and information representing location(s) of the frequency component(s) may be encoded (operation 2215).

Next, the energy value(s) of a signal(s) at a frequency band(s) less than a predetermined frequency may be calculated (operation 2220). Here, the band may be one sub band or one scale factor band in the case of a QMF.

Next, the energy values of the bands calculated in operation 2220 and information representing locations of the bands may be encoded (operation 2225).

Next, domain transformation may be performed on the audio signal by using an analysis filterbank so that the audio signal can be represented in the time domain in predetermined frequency band units (operation 2230). For example, domain transformation may be performed by applying the QMF in operation 2230.

Then, a high-frequency signal corresponding to a frequency band greater than a predetermined frequency may be encoded using a low-frequency signal corresponding to a frequency band less than the predetermined frequency (operation 2235). For the encoding, information to decode the high-frequency signal by using the low-frequency signal may be generated and encoded.

Next, a tonality(ies) of a signal(s) at a band(s) containing the frequency component(s) detected in operation 2215 may be calculated and encoded (operation 2240). However, operation 2240 is not indispensable to the present general inventive concept but may be needed if a decoding apparatus (not shown) generates a signal not from a single signal but from a plurality of signals at the band(s) containing the frequency component(s). For example, operation 2240 may be performed when the decoding apparatus generates a signal(s) at the band(s) containing the frequency component(s) by using both a signal being arbitrarily generated and a patched signal.

Next, the frequency component(s) and the information representing the location(s) of the frequency component(s) that were encoded in operation 2215, the energy values of the bands and the information representing the locations of the bands that were encoded in operation 2225, and the information to decode the high-frequency signal by using the low-frequency signal may be multiplexed into a bitstream (operation 2245). Alternatively, in operation 2245, the tonality (or tonalities) encoded in operation 2240 may also be multiplexed into the bitstream.

FIG. 23 is a flowchart illustrating a method of decoding an audio signal according to another embodiment of the present general inventive concept.

First, a bitstream may be received from an encoding terminal and then may be demultiplexed (operation 2300). For example, in operation 2300, the bitstream may be demultiplexed into one or more frequency components, information representing location(s) of the frequency component(s), the energy value of each band, information representing location(s) of a band (or bands) whose energy value(s) may be encoded by an encoding apparatus (not shown), information to decode a signal corresponding to a frequency band greater than a predetermined frequency by using a signal corresponding to a frequency band less than the predetermined frequency, and signal tonality(ies).

Next, a frequency component (or components) that was determined to be important from the low-frequency signal corresponding to a band less a predetermined frequency according to predetermined criteria, and then was encoded by the encoding apparatus, may be decoded (operation 2305).

Next, the energy value(s) of the low-frequency signal at each band may be decoded (operation 2310).

Next, a tonality(ies) of a signal(s) at a band(s) containing the frequency component(s) decoded in operation 2305 may be decoded, from among one or more frequency bands less than a predetermined frequency (operation 2315). However, operation 2315 is not indispensable to the present general inventive concept but may be needed if a signal is generated from a plurality of signals, rather than from a single signal, in operation 2315 which will be described later. For example, in operation 2320, it may be necessary to perform operation 2315 when a signal or signals are generated at the band(s) containing the decoded frequency component(s) by using both an arbitrarily generated noise signal and a patched signal. If operation 2315 is included, the tonality(ies) decoded in operation 2315 may also be considered when adjusting a signal or signals, which may be generated in operation 2320, in operation 2325.

Next, a signal having the energy value decoded in operation 2310 may be generated at each band (operation 2320).

In operation 2320, various methods can be used to generate a signal at each band. First, a noise signal may be generated arbitrarily. Second, if signals at a predetermined band have already been decoded and thus are available, then a signal may be generated by duplicating a highly related signal from among the decoded signals. For example, a signal may be generated by patching or folding one of the already decoded signals.

Then, it may be determined whether frequency bands less than a first frequency contain the decoded frequency component(s) (operation 2323).

If it is determined in operation 2323 that the frequency bands less than the first frequency contains the decoded frequency component(s), a signal or signals at the frequency bands less than the first frequency may be adjusted, from among the signal(s) generated in operation 2320 (operation 2325). Specifically, in operation 2325, the signal(s) generated in operation 2320 may be adjusted so that the energy values of the generated signal(s) can be adjusted, based on the energy value at each band decoded in operation 2310 and in consideration of the energy value(s) of the frequency component(s) decoded in operation 2305. Operation 2325 will be described later in greater detail with reference to FIG. 28.

However, if it is determined in operation 2323 that the frequency bands less than the first frequency do not contain the decoded frequency component(s), a signal or signals at the other bands that do not contain the decoded frequency component(s) from among the signal(s) generated in operation 2320 may not be adjusted.

Next, the result of mixing the frequency component(s) decoded in operation 2305 and the signal(s) adjusted in operation 2325 may be output at the band(s) containing the decoded frequency component(s) from among one or more frequency bands less than a predetermined frequency, and the signal(s) generated in operation 2320 may be output at the other bands that do not contain the decoded frequency component(s) from among the frequency band(s) less than the predetermined frequency (operation 2330). Therefore, a low-frequency signal can be restored in operation 2330.

Then, the restored low-frequency signal may be transformed from the frequency domain to the time domain according to a predetermined first inverse transformation method, in the reverse manner that transformation is performed in operation 2220 illustrated in FIG. 22 (operation 2335). An example of the first inverse transformation method is IMDCT.

Next, the domain of the low-frequency signal may be transformed using an analysis filterbank so that the signal can be represented in the time domain in predetermined frequency band units, in the reverse manner that transformation was performed in operation 2335 (operation 2340). For example, domain transformation may be performed by applying a QMF in operation 2340.

Next, it may be determined whether frames applied in operation 2305 are the same as those applied in operation 2350 (operation 2343).

If it is determined in operation 2343 that the frames are not the same, the frames applied in operation 2305 may be synchronized with the frames applied in operation 2350 (operation 2345). In operation 2345, all or some of the frames applied in operation 2350 may be processed based on the frames applied in operation 2305.

Next, a high-frequency signal corresponding to a frequency band greater than a predetermined frequency may be encoded using (operation 2350). For the decoding, the information to decode the high-frequency signal by using the low-frequency signal demultiplexed in operation 2300, may be used.

Next, it may be determined whether the frequency band(s) greater than the predetermined frequency contain(s) the decoded frequency component(s) (operation 2353).

If it is determined in operation 2353 that the band(s) contain(s) the decoded frequency component(s), a signal(s) at a band(s) containing the decoded frequency component(s) may be adjusted, from among one or more high-frequency signal decoded in operation 2350 (operation 2355).

Specifically, in operation 2355, the energy value(s) of one or more frequency components at frequency bands greater than a predetermined frequency may be calculated. Then, the high-frequency signal adjusted in operation 2350 may be adjusted so that the energy value(s) of the signal(s) that may be adjusted is equal to the value obtained by subtracting the energy value of the frequency component contained in each band from the energy value of the signal decoded in operation 2350.

Next, the result of mixing the frequency component(s) decoded in operation 2305 and the signal(s) adjusted in operation 2355 may be output at the band(s) containing the decoded frequency component(s) from among the frequency bands greater than the predetermined frequency, and the signal(s) decoded in operation 2350 may be output at the other bands that do not contain the decoded frequency component(s) from among the frequency bands greater than the predetermined frequency (operation 2360). Accordingly, a high-frequency signal can be restored in operation 2360.

Then, the domain of the restored high-frequency signal may be inversely transformed using a synthesis filterbank, in the reverse manner that transformation may be performed in operation 2340 (operation 2365).

Thereafter, the original audio signal may be restored by mixing the low-frequency signal being inversely transformed in operations 2335 and the high-frequency signal being inversely transformed in operation 2365 (operation 2370).

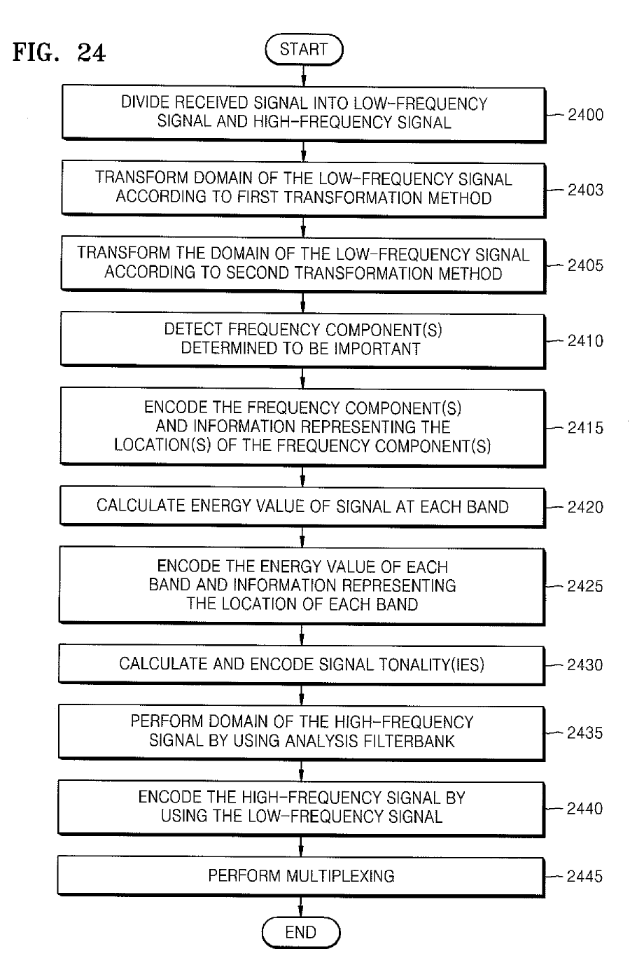

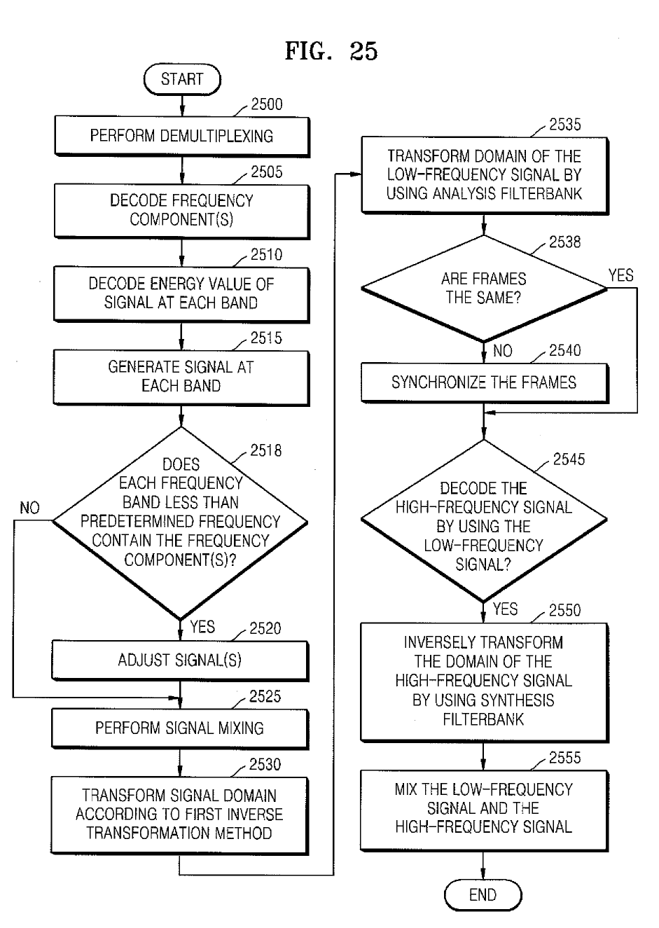

FIG. 24 is a flowchart illustrating a method of encoding an audio signal according to another embodiment of the present general inventive concept.

First, a received signal may be divided into a low-frequency signal and a high-frequency signal, based on a predetermined frequency (operation 2400). Here, the low-frequency signal corresponds to a frequency band less than the predetermined first frequency and the high-frequency signal corresponds to a frequency band greater than the predetermined second frequency. In one aspect of the present general inventive concept, the first frequency and the second frequency may be the same, but it is understood the first frequency and the second frequency may also be different from each other.

Next, the low-frequency signal obtained in operation 2400 may be transformed from the time domain to the frequency domain according to a predetermined first transformation method (operation 2403).

Next, the low-frequency signal may be further transformed from the time domain to the frequency domain according to a predetermined second transformation method that may be different to the first transformation method, in order to apply a psychoacoustic model (operation 2405).

The signal transformed in operation 2403 may be used to encode the low-frequency signal, and the signal transformed in operation 2405 may be used to detect important frequency components by applying a psychoacoustic model to the low-frequency signal. Here, the psychoacoustic model may be a mathematical model regarding a masking reaction of the human auditory system.

For example, in operation 2403, the low-frequency signal may be represented with real numbers by transforming it into the frequency domain by using MDCT as the first transformation method, and in operation 1605, the audio signal may be represented with imaginary numbers by transforming it into the frequency domain by using MDST as the second transformation method. Here, the signal represented with real numbers as a result of using MDCT may be used to encode the audio signal, and the signal represented with imaginary numbers as a result of using MDST may be used to detect important frequency components by applying the psychoacoustic model to the audio signal. Accordingly, since the phase information of the audio signal can be further represented, DFT may be performed on the signal corresponding to the time domain and then MDCT coefficients may be quantized, thereby preventing a mismatch from occurring.

Next, one or more frequency components determined to be important may be detected from the low-frequency signal transformed in operation 2403 according to predetermined criteria, by using the signal transformed in operation 2405 (operation 2410). Various methods can be used to detect an important frequency component(s) in operation 2410. First, the SMR of a signal may be calculated, and then, the signal may be determined to be an important frequency component if the value of the signal is greater than the reciprocal of a masking value. Second, whether a signal is an important frequency component may be determined by extracting a spectrum peak in consideration of a predetermined weight. Third, the SNR of each of sub bands may be calculated and then a frequency component(s) having a peak value equal to or greater than a predetermined value may be selected as an important frequency component(s) from among sub bands having a small SNR. The above three methods may be individually performed, or one or a combination of at least two of the three methods may be performed. The above three methods are just examples and thus the present general inventive concept is not limited thereto.

Then, the frequency component(s) detected in operation 2410 and information representing location(s) of the frequency component(s) may be encoded (operation 2415).

Next, the energy value(s) of one or more signals at each band of the low-frequency signal transformed in operation 2403 may be calculated (operation 2420). Here, the band may be one sub band or one scale factor band in the case of a QMF.

Next, the energy values of the bands calculated in operation 2420 and information representing locations of the bands may be encoded (operation 2425).

Next, a tonality of each of one or more signals at a band or bands containing the frequency component(s) detected in operation 2410 may be calculated and encoded (operation 2430). However, operation 2430 is not indispensable to the present general inventive concept but may be needed if a decoding apparatus (not shown) generates a signal not from a single signal but from a plurality of signals at the band(s) containing the frequency component(s). For example, operation 2430 may be performed when the decoding apparatus generates a signal or signals at the band(s) containing the frequency component(s) by using both a noise signal being arbitrarily generated and a patched signal.

Next, domain transformation may be performed on the high-frequency signal obtained in operation 2400 by using an analysis filterbank so that this signal can be represented in the time domain in predetermined frequency band units (operation 2435). For example, domain transformation may be performed by applying the QMF in operation 2435.

Next, the high-frequency signal transformed in operation 2430 may be encoded using the low-frequency signal (operation 2440). For the encoding, information to decode the high-frequency signal by using the low-frequency signal may be generated and encoded.

Next, the frequency component(s) and the information representing the location(s) of the frequency component(s) that were encoded in operation 2415, the energy values of the bands and the information representing the locations of the bands that were encoded in operation 2425, and the encoded information to decode the high-frequency signal by using the low-frequency signal may be multiplexed together into a bitstream, and then, the bitstream may be output (operation 2445). Alternatively, in operation 2445, the tonality (or tonalities) encoded in operation 2430 may also be multiplexed into the bitstream.

FIG. 25 is a flowchart illustrating a method of decoding an audio signal according to another embodiment of the present general inventive concept.

First, a bitstream may be received from an encoding terminal and then may be demultiplexed (operation 2500). For example, in operation 2500, the bitstream may be demultiplexed into one or more frequency components; information representing location(s) of the frequency component(s); the energy value of each band; information representing location(s) of a band(s) whose energy value(s) may be encoded by an encoding apparatus (not shown); information to decode a high-frequency signal by using a low-frequency signal; and a signal tonality(ies). Here, the low-frequency signal corresponds to a frequency band less than a predetermined first frequency and the high-frequency signal corresponds to a frequency band greater than a predetermined second frequency. In one aspect of the present general inventive concept, the first and second frequencies may be the same, but it is understood the first frequency and the second frequency may also be different from each other.

Next, one or more frequency components that were determined to be important according to predetermined criteria and then encoded by the encoding apparatus, may be decoded (operation 2505).

Next, the energy value of a signal at each of one or more frequency bands less than a predetermined frequency may be decoded (operation 2510).

Next, a signal having one of the decoded energy values may be generated in band units (operation 2515).

In operation 2515, various methods can be used to generate a signal at each band. First, a noise signal may be generated arbitrarily. Second, if a signal at a predetermined band corresponds to a high-frequency band and a signal corresponding to a low-frequency band has already been decoded and thus is available, then a signal may be generated by duplicating the signal corresponding to the low-frequency band. For example, a signal may be generated by patching or folding the signal corresponding to the low-frequency band.

Then, it may be determined whether the frequency band(s) less than the predetermined frequency contains the frequency component(s) decoded in operation 2505 (operation 2518).

If it is determined in operation 2518 that the band(s) contains the decoded frequency component(s), a signal or signals at the band(s) containing the frequency component(s) may be adjusted, from among the signal(s) generated in operation 2515 (operation 2520). Specifically, in operation 2120, the signal(s) generated in operation 2515 may be adjusted so that the energy values of the generated signal(s) can be adjusted, based on the energy value(s) decoded in operation 2510 and in consideration of the energy value(s) of the frequency component(s) decoded in operation 2505. Operation 2520 will be described later in greater detail with reference to FIG. 28.

However, if it is determined in operation 2518 that the band(s) does not contain the decoded frequency component(s), a signal or signals at the band(s) may not be adjusted, from among the signal(s) generated in operation 2515.

Next, the result of mixing the frequency component(s) decoded in operation 2505 and the signal(s) adjusted in operation 2520 may be output at the band(s) containing the decoded frequency component(s) from among the frequency band(s) less than the predetermined frequency, and the signal(s) generated in operation 2515 may be output at the other bands that do not contain the decoded frequency component(s) from among the frequency bands less than the predetermined frequency (operation 2525). Accordingly, the low-frequency signal can be restored in operation 2525.

Then, the signals output in operation 2525 may be transformed from the frequency domain to the time domain according to a predetermined first inverse transformation method, in the reverse manner that transformation may be performed in operation 2403 (operation 2530). An example of the first inverse transformation method is IMDCT.

Next, domain transformation may be performed on the low-frequency signal by using an analysis filterbank so that this signal can be represented in the time domain in predetermined frequency band units, in the reverse manner that transformation was performed in operation 2530 (operation 2535). For example, domain transformation may be performed by applying a QMF in operation 2535.

Next, it may be determined whether frames applied in operation 2505 are the same as those applied in operation 2545 (operation 2538).

If it is determined in operation 2538 that the frames are not the same, the frames applied in operation 2505 may be synchronized with the frames applied in operation 2545 (operation 2540). In operation 2540, all or some of the frames applied in operation 2545 may be processed based on the frames applied in operation 2505.

Then, the high-frequency signal may be decoded using the low-frequency signal transformed in operation 2535 (operation 2545). For the decoding, the information to decode the high-frequency signal by using the low-frequency signal demultiplexed in operation 2500 may be used.

Next, the domain of the high-frequency signal decoded in operation 2545 may be inversely transformed using a synthesis filterbank in the reverse manner that transformation was performed in operation 2535 (operation 2550).

Thereafter, the original audio signal may be restored by mixing the low-frequency signal being inversely transformed in operation 2530 and the high-frequency signal being inversely transformed in operation 2550 (operation 2555).

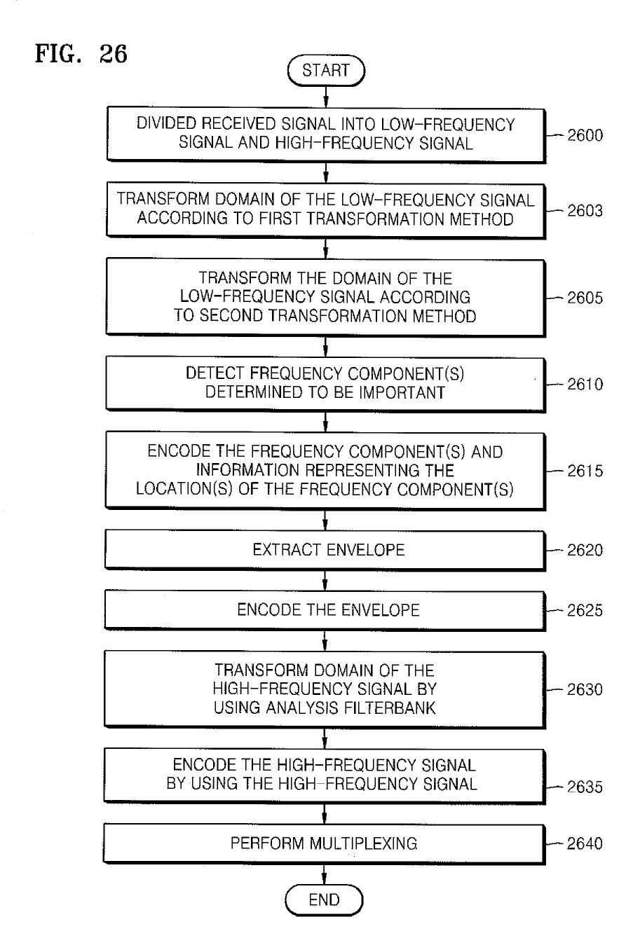

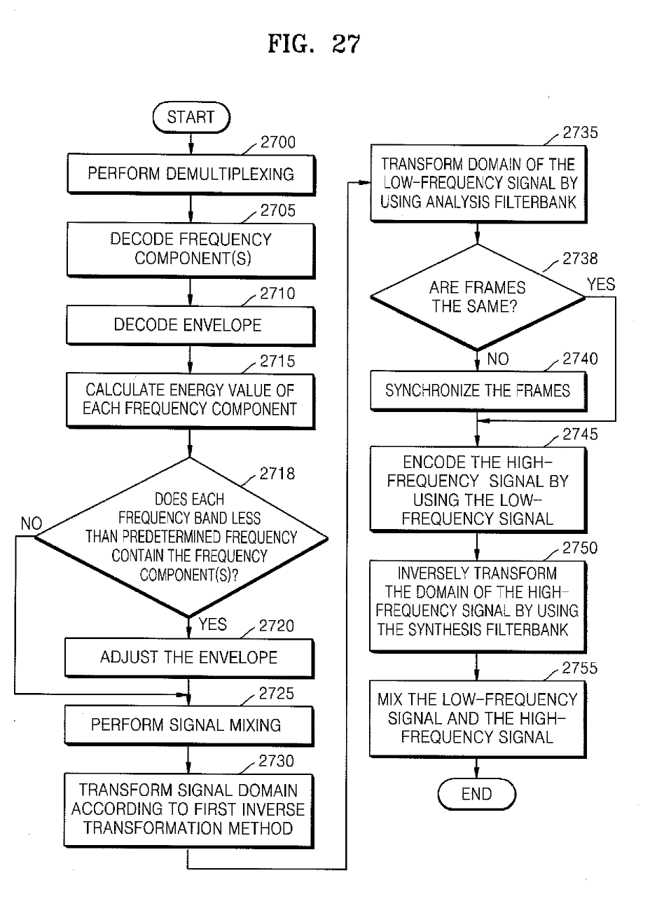

FIG. 26 is a flowchart illustrating a method of encoding an audio signal according to another embodiment of the present general inventive concept.

First, a signal received via an input terminal IN may be divided into a low-frequency signal and a high-frequency signal based on a predetermined frequency (operation 2600). Here, the low-frequency signal corresponds to a frequency band less than a predetermined first frequency and the high-frequency signal corresponds to a frequency band greater than a predetermined second frequency. The first frequency and the second frequency may be the same but may be different from each other.

Next, the low-frequency signal obtained in operation 2600 may be transformed from the time domain to the frequency domain according to a predetermined first transformation method (operation 2603).

Next, the low-frequency signal may be further transformed from the time domain to the frequency domain according to a predetermined second transformation method that may be different to the first transformation method, in order to apply a psychoacoustic model (operation 2605).

The signal transformed in operation 2603 may be used to encode the low-frequency signal, and the signal transformed in operation 2605 may be used to detect important frequency components by applying a psychoacoustic model to the low-frequency signal. Here, the psychoacoustic model may be a mathematical model regarding a masking reaction of the human auditory system.

For example, in operation 2603, the low-frequency signal may be expressed with real numbers by transforming it into the frequency domain by using MDCT as the first transformation method, and in operation 2605, the low-frequency signal may be expressed with imaginary numbers by transforming it into the frequency domain by using MDST as the second transformation method. Here, the signal expressed with real numbers as a result of using MDCT may be used to encode the low-frequency signal, and the signal expressed with imaginary numbers as a result of using MDST may be used to detect important frequency components by applying the psychoacoustic model to the low-frequency signal. Accordingly, since the phase information of the audio signal can be further expressed, DFT may be performed on the signal corresponding to the time domain and then MDCT coefficients may be quantized, thereby preventing a mismatch from occurring.

Next, one or more frequency components determined to be important may be detected from the low-frequency signal transformed in operation 2603 according to predetermined criteria, by using the signal transformed in operation 2605 (operation 2610). Various methods can be used to detect an important frequency component in operation 2610. First, the SMR of a signal may be calculated, and then the signal may be determined to be an important frequency component if the value of the signal is greater than the reciprocal of a masking value. Second, whether a signal is an important frequency component may be determined by extracting a spectrum peak in consideration of a predetermined weight. Third, the SNR of each of sub bands may be calculated and then a frequency component having a peak value equal to or greater than a predetermined value may be selected as an important frequency component from among sub bands having a small SNR. The above three methods may be individually performed, or one or a combination of at least two of the three methods may be performed. The above three methods are just examples and thus the present general inventive concept is not limited thereto.

Then, the frequency component(s) detected in operation 2610 and information representing location(s) of the frequency component(s) may be encoded (operation 2615).

Next, an envelope of the low-frequency signal transformed in operation 2603 may be extracted (operation 2620).

Next, the extracted envelope may be encoded (operation 2625).

Next, domain transformation may be performed on the high-frequency signal obtained in operation 2600 by using an analysis filterbank so that this signal can be represented in the time domain in predetermined frequency band units (operation 2630). For example, domain transformation may be performed by applying a QMF in operation 2630.

Next, the high-frequency signal transformed in operation 2630 may be encoded using the high-frequency signal (operation 2635). For the encoding, the information to decode the high-frequency signal by using the low-frequency signal may be generated and encoded.

Thereafter, the frequency component(s) and the information representing the location(s) of the frequency component(s) that may be encoded in operation 2605, the envelope of the low-frequency signal encoded in operation 2625, and the information to decode the high-frequency signal by using the low-frequency signal, which was encoded in operation 2635, may be multiplexed into a bitstream (operation 2640).

FIG. 27 is a flowchart illustrating a method of decoding an audio signal according to another embodiment of the present general inventive concept.

First, a bitstream may be received from an encoding terminal and then may be demultiplexed (operation 2700). For example, in operation 2700, the bitstream may be demultiplexed into one or more frequency components, information representing location(s) of the frequency component(s), an envelope of a low-frequency signal encoded by an encoding apparatus (not shown), and information to decode a high-frequency signal by using the low-frequency signal. Here, the low-frequency signal corresponds to a frequency band less than a predetermined first frequency and the high-frequency signal corresponds to a frequency band greater than a predetermined second frequency. In one aspect of the present general inventive concept, the first and second frequencies may be the same, but it is understood the first frequency and the second frequency may also be different from each other.

Next, one or more frequency components that were determined to be important according to predetermined criteria and then encoded by the encoding apparatus, may be decoded (operation 2705).

Next, the envelope(s) of the low-frequency signal encoded by the encoding apparatus may be decoded (operation 2710).

Next, the energy value(s) of the frequency component(s) decoded in operation 2705 may be calculated (operation 2715).

Then, it may be determined whether one or more frequency bands less than the predetermined frequency contain the decoded frequency component(s) (operation 2718).

If it is determined in operation 2718 that the band(s) contains the decoded frequency component(s), one or more envelopes at the band(s) may be adjusted, from among the envelope(s) decoded in operation 2710 (operation 2720). Specifically, in operation 2720, the envelope(s) decoded in operation 2710 may be adjusted so that the energy value(s) of the decoded envelope(s) may be equal to the value obtained by subtracting the energy value(s) of the decoded frequency component(s) from the energy value(s) of the decoded envelope(s) at the band(s) containing the decoded frequency component(s).

However, if it is determined in operation 2718 that the band(s) do(es) not contain the decoded frequency component(s), one or more envelopes at the band(s) may not be adjusted, from among the envelope(s) decoded in operation 2710.

Next, the result of mixing the frequency component(s) decoded in operation 2705 and the envelope(s) adjusted in operation 2720 may be output at the band(s) containing the decoded frequency component(s) from among the frequency band(s) less than the predetermined frequency, and the signal(s) decoded in operation 2710 may be output at the other bands that do not contain the decoded frequency component(s) from among the frequency bands less than the predetermined frequency (operation 2725). Accordingly, the low-frequency signal can be restored in operation 2725.

Then, the restored low-frequency signal may be transformed from the frequency domain to the time domain according to a predetermined first inverse transformation method, in the reverse manner that transformation may be performed in operation 2603 of FIG. 26 (operation 2730). An example of the first inverse transformation method is IMDCT.

Next, domain transformation may be performed on the low-frequency signal by using an analysis filterbank so that this signal can be represented in the time domain in predetermined frequency band units, in the reverse manner that transformation was performed in operation 2730 (operation 2735). For example, domain transformation may be performed by applying a QMF in operation 2735.

Next, it may be determined whether frames applied in operation 2705 as the same as those applied in operation 2745 (operation 2738).

If it is determined in operation 2738 that the frames are not the same, the frames applied in operation 2705 may be synchronized with the frames applied in operation 2745 (operation 2740). In operation 2740, all or some of the frames applied in operation 2745 may be processed based on the frames applied in operation 2705.

Then, the high-frequency signal may be restored using the low-frequency signal transformed in operation 2735 (operation 2745). For the decoding, the information to decode the high-frequency signal by using the low-frequency signal demultiplexed in operation 2700 may be used.

Next, the domain of the high-frequency signal decoded in operation 2745 may be inversely transformed using a synthesis filterbank in the reverse manner that transformation was performed in operation 2735 (operation 2750).

Thereafter, the original audio signal may be restored by mixing the low-frequency signal being inversely transformed in operation 2730 and the high-frequency signal being inversely transformed in operation 2750 (operation 2755).

FIG. 28 is a flowchart illustrating in detail operation 1720, 2120, 2325 or 2520 illustrated in FIG. 17, 21, 23 or 25, respectively, according to an embodiment of the present general inventive concept.

First, in operation 1715, 2115, 2320 or 2515, one or more signals at one or more bands that contain one or more frequency components may be received and then the energy value(s) of the signal(s) at the band(s) may be calculated (operation 2800).

Then, one or more frequency components decoded in operation 1705, 2105, 2305 or 2505 may be received and then the energy value(s) of the frequency component(s) may be calculated (operation 2805).

Next, the gain(s) of the energy value(s) of the band(s) containing the decoded frequency component(s) that were decoded in operation 1710, 2110, 2310 or 2510 may be calculated so as to satisfy a relationship whereby the energy value(s) calculated in operation 2800 may be equal to the value obtained by subtracting the energy value(s) calculated in operation 2805 from the energy value(s) decoded in operation 1710, 2110, 2310 or 2510 (operation 2810). For example, in operation 2810, the gain(s) of the energy value(s) may be calculated as follows:

$$g = \sqrt{\frac{{E}_{target} - {E}_{core}}{{E}_{seed}}} , \qquad ( 2 )$$

wherein E_{target} denotes the energy value(s) decoded in operation 1710, 2110, 2310 or 2510, E_{core} denotes the energy value(s) calculated in operation 2805, and E_{seed} denotes the energy value(s) calculated in operation 2800.

In operation 2810, if signal tonality is also considered in the gain calculation in operation 2810, the energy value(s) at the band(s) containing the frequency component(s) decoded in operation 2805 may be received, a tonality(ies) of the signal(s) at the band(s) may be received, and then, the gain(s) may be calculated using the received energy value(s), the received tonality(ies), and the energy value(s) may be calculated in operation 2805.

Then, the calculated gain(s) for each band may be applied to one or more signals at the band(s) containing the decoded frequency component(s), which may be generated in operation 1715, 2115, 2320 or 2515 (operation 2815).

The present general inventive concept can be embodied as computer readable codes on a computer readable medium including apparatuses having an information processing function. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

In a method and apparatus to encode an audio signal according to the present general inventive concept, one or more important frequency components may be detected from the audio signal and then may be encoded, and an envelope for the audio signal may be encoded. Also, according to the method and apparatus, the audio signal may be decoded by controlling one or more envelopes at one or more bands containing the important frequency component(s) in consideration of the energy value(s) of the important frequency component(s).

Accordingly, it is possible to maximize the efficiency of coding without degrading the sound quality of an audio signal even if the audio signal is encoded or decoded using a small amount of bits.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of encoding an audio signal, the method comprising:
detecting one or more frequency components from a received audio signal according to predetermined criteria, and then encoding the detected one or more frequency components; and
calculating energy values of the received signal in predetermined frequency band units, and then encoding the calculated energy values.

2. The method of claim 1, further comprising encoding a tonality of each of one or more signals at one or more predetermined bands.

3. A method of encoding an audio signal, the method comprising:
detecting one or more frequency components from a plurality of received signals according to predetermined criteria, and then encoding the detected one or more frequency components;
calculating an energy value of each of one or more signals having a frequency band less than a predetermined frequency from among the received signals, in predetermined frequency band units, and then encoding the energy values; and
encoding one or more signals having a frequency band greater than the predetermined frequency by using the one or more signals having a frequency band less than the predetermined frequency.

4. The method of claim 3, further comprising encoding a tonality of each of one or more signals at one or more predetermined bands.

5. A method of decoding an audio signal, the method comprising:
decoding one or more frequency components;
decoding an energy value of each of one or more signals to be respectively generated at bands;
calculating an energy value of each of the one or more signals, based on the decoded energy values and in consideration of energy values of the decoded frequency components;
respectively generating the one or more signals having one of the calculated energy values at the bands; and
mixing the frequency components and the generated signals.

6. The method of claim 5, wherein during the calculating of the energy values, the energy values of the one or more signals to be generated at each band are calculated by subtracting the energy value of each of the frequency components each of which are contained in one of the bands from the decoded energy value at each band.

7. The method of claim 5, wherein during the generating of the one or more signals, the one or more signals are arbitrarily generated.

8. The method of claim 5, wherein during the generating of the one or more signals, the one or more signals are generated by duplicating one or more signals corresponding to frequency bands less than a predetermined frequency.

9. The method of claim 5, wherein during the generating of the one or more signals, the one or more signals are generated using one or more signals corresponding to a frequency band less than a predetermined frequency.

10. The method of claim 5, further comprising decoding a tonality of each of one or more predetermined bands.

11. The method of claim 10, wherein during the calculating of the energy value, the tonality of each of the one or more predetermined bands is also considered.

12. A method of decoding an audio signal, the method comprising:
decoding one or more frequency components;
encoding one or more envelopes of the audio signal;
adjusting the one or more envelopes at respective bands in consideration of energy values of the one or more frequency components at the respective bands; and
mixing the one or more frequency components and the adjusted envelopes.

13. The method of claim 12, wherein during the adjusting of the envelopes, the envelope at each band is adjusted so that the energy value of the decoded envelope at each band is equal to the value obtained by subtracting an energy value of each of the one or more frequency components contained in the bands from the energy value of an envelope at each of the bands containing the one or more decoded frequency components.

14. A method of decoding an audio signal, the method comprising:
decoding one or more frequency components;
decoding an energy value of a signal at each of a plurality of frequency bands less than a predetermined frequency;
calculating an energy value of a signal to be generated at each band, based on one of the decoded energy values and in consideration of an energy value of each of the one or more frequency components;
generating a signal having one of the calculated energy values at each frequency band less than the predetermined frequency;
decoding a signal at each frequency band greater than the predetermined frequency by using the signal at each band less than the predetermined frequency;
adjusting the signal at each frequency band greater than the predetermined frequency in consideration of the energy values of the one or more frequency components at the respective bands; and
mixing the one or more frequency components, the generated signals, and the adjusted signals.

15. The method of claim 14, wherein during the calculating of the energy values, the energy value of a signal to be generated at each band is calculated by subtracting the energy value of one of the one or more frequency components contained in the respective bands from the decoded energy value of each band.

16. The method of claim 14, wherein during the generating of the signals, the signals are arbitrarily generated.

17. The method of claim 14, wherein during the generating of the signals, the signals are generated by duplicating the signal at each frequency band less than the predetermined frequency.

18. The method of claim 14, wherein during the generating of the signals, the signals are generated using the signal at each frequency band less than the predetermined frequency.

19. The method of claim 14, further comprising decoding a tonality of each of one or more predetermined frequency bands.

20. The method of claim 19, wherein during the calculating of the energy values, the tonality of each of the predetermined bands is also considered.

21. The method of claim 14, further comprising performing frame synchronization if frames applied to the decoding of the one or more frequency components are not the same as frames applied to the generating of the signals or the decoding of the signal at each frequency band greater than the predetermined frequency.
